(19) United States
(12) Patent Application Publication
(10) Pub. No.: US 2025/0063149 A1
(43) Pub. Date: Feb. 20, 2025

(54) PROJECTION METHOD, PROJECTOR, AND NON-TRANSITORY COMPUTER-READABLE STORAGE MEDIUM STORING PROGRAM

(71) Applicant: SEIKO EPSON CORPORATION, Tokyo (JP)

(72) Inventors: Yoshiteru UCHIYAMA, SUWA-SHI (JP); Jun YOSHIMURA, HIJI-MACHI (JP)

(21) Appl. No.: 18/806,796

(22) Filed: Aug. 16, 2024

(30) Foreign Application Priority Data
Aug. 17, 2023 (JP) 2023-132832

(51) Int. Cl. H04N 9/31

(52) U.S. Cl. CPC H04N 9/3188; H04N 9/317

(57) ABSTRACT

A projection method including: projecting, by a main body including a light modulation device that is configured to draw a drawn image and a projection image obtained by reducing the drawn image, and that is configured to modulate light from a light source, the drawn image or the projection image on a projection surface; receiving a first operation for moving the projection image with respect to the projection surface or a second operation for expanding the projection image; and moving the projection image along an outer edge of the drawn image in accordance with the first operation or the second operation when the projection image makes contact with the outer edge by receiving the first operation or the second operation and when the first operation or the second operation continues.

The present application is based on, and claims priority from JP Application Serial Number 2023-132832, filed Aug. 17, 2023, the disclosure of which is hereby incorporated by reference herein in its entirety.

### BACKGROUND

### 1. Technical Field

The present disclosure relates to a projection method, a projection display device, and a non-transitory computer-readable storage device storing a program.

### 2. Related Art

There has been known a projection display device which modulates light emitted from a light source with a light modulation device in accordance with an image signal to form an optical image, and then projects the optical image in an enlarged manner on a projection surface with an optical system such as a lens. In such a projection display device, in when restrictions in an installation place or installation time is significant, the projection display device is not necessarily installed in front of the projection surface, but is required to be installed in many cases in a state in which the optical axis of the projection display device is inclined with respect to the projection surface.

For this reason, there is known a technique in which the position and the shape of the projection image, which is an optical image corresponding to image data, are adjusted in accordance with an operation by a user in a region that can be modulated by the light modulation device (see, e.g., JP-A-2006-246306).

JP-A-2006-246306 is an example of the related art.

However, in the technique described above, for example, when changing the position of the projection image, the translation of the projection image is stopped at the time when an outer frame of the projection image reaches an outer edge of the region that can be modulated by the light modulation device irrespective of the operation by the user. Such stoppage is an action contrary to the operation by the user, and thus there is a problem that the operability is not good for the user.

### SUMMARY

In view of the problem described above, a projection method according to an aspect of the present disclosure includes: projecting, by a main body including a light modulation device that is configured to draw a drawn image and a projection image obtained by reducing the drawn image and that is configured to modulate light from a light source, the drawn image or the projection image on a projection surface; receiving a first operation for moving the projection image relative to the projection surface or a second operation for expanding the projection image; and moving the projection image along an outer edge of the drawn image in accordance with the first operation or the second operation when the projection image makes contact with the outer edge due to the first operation or the second operation and when the first operation or the second operation continues.

In view of the problem described above, a projector according to another aspect of the present disclosure includes: a light modulation device configured to draw a drawn image and a projection image obtained by reducing the drawn image; a projection lens configured to project the drawn image or the projection image onto a projection surface; an operator configured to designate a first operation for moving the projection image relative to the projection surface or a second operation for expanding the projection image; and a control device configured to move the projection image along an outer edge of the drawn image in accordance with the first operation or the second operation when the projection image makes contact with the outer edge due to the first operation or the second operation designated by the operator and when the first operation or the second operation continues.

In view of the problem described above, a non-transitory computer-readable storage medium storing a program according to still another aspect of the present disclosure is configured to cause a computer that is configured to control a light modulation device, the light modulation device being configured to draw a drawn image and a projection image obtained by reducing the drawn image and being configured to modulate light from a light source, to execute processing including: receiving a first operation for moving the projection image relative to a projection surface or a second operation for expanding the projection image; and moving the projection image along an outer edge of the drawn image in accordance with the first operation or the second operation when the projection image makes contact with the outer edge due to the first operation or the second operation and when the first operation or the second operation continues.

### BRIEF DESCRIPTION OF THE DRAWINGS

FIG. 1 is a diagram showing a projection display device to which a projection method according to an embodiment is applied.

FIG. 2 is a diagram showing an optical configuration of the projection display device.

FIG. 3 is a block diagram showing an electrical configuration of the projection display device.

FIG. 4 is a block diagram configured with a control device in the projection display device.

FIG. 5 is a diagram illustrating an example of a drawn image projected on a projection surface by the projection display device.

FIG. 6 is a diagram illustrating an example of correction of a projection image in the drawn image.

FIG. 7 is a diagram illustrating an example of the correction of the projection image in the drawn image.

FIG. 8 is a diagram illustrating the projection image in a liquid crystal panel.

FIG. 9 is a diagram illustrating reduction of the projection image in the drawn image.

FIG. 10 is a diagram illustrating reduction of the projection image in the liquid crystal panel.

FIG. 11 is a diagram illustrating translation of the projection image in the drawn image.

FIG. 12 is a diagram illustrating translation of the projection image in the liquid crystal panel.

FIG. 13 is a diagram illustrating translation of the projection image in the drawn image.

FIG. 14 is a diagram illustrating translation of the projection image in the liquid crystal panel.

FIG. 15 is a flowchart showing translation, reduction, and expansion operations in the projection image.

FIG. 16 is a flowchart showing the translation, reduction, and expansion operations in the projection image.

FIG. 17 is a diagram illustrating an expansion prohibition condition of the projection image with respect to the drawn image.

FIG. 18 is a diagram illustrating an expansion prohibition condition of the projection image with respect to the drawn image.

FIG. 19 is a diagram illustrating an expansion prohibition condition of the projection image with respect to the drawn image.

FIG. 20 is a diagram illustrating the expansion prohibition condition of the projection image with respect to the drawn image.

FIG. 21 is a diagram illustrating an expansion prohibition condition of the projection image with respect to the drawn image.

FIG. 22 is a diagram illustrating the expansion prohibition condition of the projection image with respect to the drawn image.

FIG. 23 is a diagram illustrating an expansion prohibition condition of the projection image with respect to the drawn image.

FIG. 24 is a diagram illustrating the expansion prohibition condition of the projection image with respect to the drawn image.

FIG. 25 is a diagram illustrating an example of the drawn image and the projection image projected on the projection surface.

FIG. 26 is a diagram illustrating an example of the projection image in the liquid crystal panel.

FIG. 27 is a diagram illustrating translation of the projection image in the drawn image.

FIG. 28 is a diagram illustrating translation of the projection image in the liquid crystal panel.

FIG. 29 is a diagram illustrating an example in which moving speed of the projection image changes in the liquid crystal panel.

FIG. 30 is a diagram illustrating contact of the projection image in the drawn image.

FIG. 31 is a diagram illustrating contact of the projection image in the liquid crystal panel.

FIG. 32 is a diagram illustrating translation of the projection image in the drawn image.

FIG. 33 is a diagram illustrating translation of the projection image in the liquid crystal panel.

FIG. 34 is a diagram illustrating prohibition of the translation of the projection image in the drawn image.

FIG. 35 is a diagram illustrating prohibition of the translation of the projection image in the liquid crystal panel.

FIG. 36 is a diagram illustrating expansion of the projection image in the drawn image.

FIG. 37 is a diagram illustrating expansion of the projection image in the drawn image.

FIG. 38 is a diagram illustrating prohibition of the expansion of the projection image in the drawn image.

FIG. 39 is a diagram illustrating a state in which the translation of the projection image is prohibited.

FIG. 40 is a diagram illustrating a state in which the translation of the projection image is permitted.

### DESCRIPTION OF EMBODIMENTS

A projection method of a projection display device according to an embodiment will hereinafter be described with reference to the drawings. Note that in the drawings, dimensions and scales of the elements are appropriately made different from actual ones. Further, the following embodiment is preferable specific example of the present disclosure and therefore various technically preferable limitations are imposed thereon, however, the scope of the present disclosure is not limited to the embodiment unless there is a description that the present disclosure is limited thereto in particular in the following description.

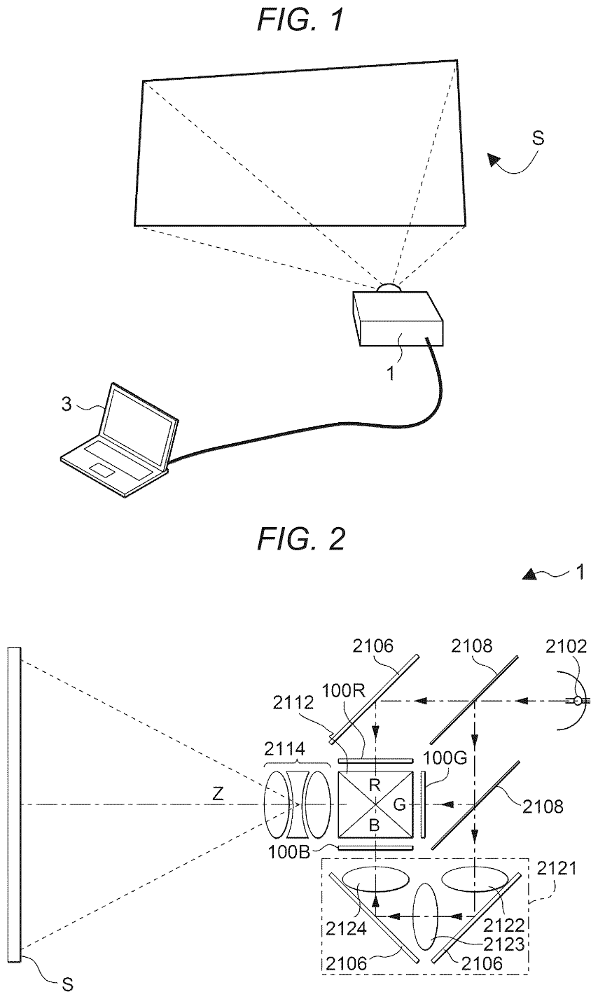

FIG. 1 is a diagram illustrating an outline of a projection display device 1 to which the projection method is applied. As shown in the drawing, the projection display device 1 is a so-called projector, and projects an image represented by image data supplied from a host device 3 onto a projection surface S such as a screen or a wall surface. The projection display device 1 is not necessarily installed in front of the projection surface S due to restrictions in an installation location, an installation time, and so on. An image projected in a state where the optical axis of the projection display device 1 is inclined with respect to the projection surface S is distorted as shown in the drawing. Therefore, as described later, the image represented by the image data is adjusted so as to be projected into a rectangle when projected, and further, the image adjusted into the rectangle is translated, expanded, or reduced.

FIG. 2 is a diagram showing an optical configuration of the projection display device 1. As shown in the drawing, the projection display device 1 includes liquid crystal panels 100R, 100G, and 100B which are examples of a light modulation device. In addition, a lamp unit 2102 formed of a white light source such as a halogen lamp is disposed inside the projection display device 1. Projection light emitted from the lamp unit 2102 is separated into three primary colors of red (R), green (G), and blue (B) by three mirrors 2106 and two dichroic mirrors 2108 disposed inside. Among these, R light is incident on the liquid crystal panel 100R, G light is incident on the liquid crystal panel 100G, and B light is incident on the liquid crystal panel 100B.

Note that since a B optical path is longer than an R optical path and a G optical path, it is necessary to prevent a loss in the B optical path. Therefore, a relay lens system 2121 including an incident lens 2122, a relay lens 2123, and an exit lens 2124 is disposed on the B optical path.

As is well known, the liquid crystal panel 100R includes a plurality of pixel circuits. Each of the plurality of pixel circuits includes a liquid crystal element. That is, the liquid crystal panel 100R includes a plurality of liquid crystal elements arranged in a matrix along a first direction and a second direction orthogonal to the first direction. The outer shape of the liquid crystal panel 100R is a rectangle having four sides orthogonal to each other when viewed from a third direction orthogonal to the first direction and the second direction. The transmittance of the liquid crystal element of the liquid crystal panel 100R changes according to the voltage of a data signal corresponding to R by being driven based on that data signal. Therefore, in the liquid crystal panel 100R, an R transmission image is generated by individually controlling the transmittances of the liquid crystal elements. Similarly, in the liquid crystal panel 100G, a G transmission image is generated based on a data signal corresponding to G, and in the liquid crystal panel 100B, a B transmission image is generated based on a data signal corresponding to B.

As is well known, the liquid crystal panel 100R includes a plurality of pixel circuits. Each of the plurality of pixel circuits includes a liquid crystal element. The liquid crystal element of the liquid crystal panel 100R is provided with the transmittance corresponding to the voltage of the data signal corresponding to R by being driven based on that data signal. Therefore, in the liquid crystal panel 100R, an R transmission image is generated by individually controlling the transmittances of the liquid crystal elements. Similarly, in the liquid crystal panel 100G, a G transmission image is generated based on a data signal corresponding to G, and in the liquid crystal panel 100B, a B transmission image is generated based on a data signal corresponding to B.

The transmission images of the respective colors generated by the liquid crystal panels 100R, 100G, and 100B are incident on the dichroic prism 2112 from three directions. In the dichroic prism 2112, the R light and the B light are refracted by 90 degrees, while the G light travels straight. Accordingly, the dichroic prism 2112 synthesizes the images of the respective colors. That is, the color images are synthesized by additive color mixing with the liquid crystal panels 100R, 100G, and 100B. Note that the color image thus synthesized is rectangular in plan view. The plan view refers to when viewed from a point along the emission axis Z of the dichroic prism 2112.

The color image synthesized by the dichroic prism 2112 is incident on a projection lens 2114. The projection lens 2114 projects the color image synthesized by the dichroic prism 2112 onto the projection surface S in an enlarged manner.

Note that the transmission images of the liquid crystal panels 100R, 100B are projected after being reflected by the dichroic prism 2112, while the transmission image of the liquid crystal panel 100G is projected after traveling straight. Therefore, the transmission images of the liquid crystal panels 100R, 100B are in a horizontally-flipped relationship with respect to the transmission image of the liquid crystal panel 100G.

Further, the liquid crystal panel 100R has a maximum range in which the R transmission image can be generated based on the data signal corresponding to R. That is, the liquid crystal panel 100R has a maximum drawing range. The maximum drawing range is an entire area in which the plurality of liquid crystal elements is arranged in the liquid crystal panel 100R. The maximum drawing range has a rectangular shape when viewed from the third direction. Since the R transmission image is partially missing when a drawn image that exceeds the maximum drawing range is drawn on the liquid crystal panel 100R, the liquid crystal panel 100R is configured so that the drawn image is drawn within the maximum drawing range. The same applies to the liquid crystal panels 100G, 100B.

The liquid crystal panels 100R, 100G, and 100B differ only in the color of the incident light, that is, in the wavelength range, and are substantially the same in structure. Therefore, the liquid crystal panels 100R, 100G, and 100B will be described with a reference numeral 100 when it is not necessary to describe them specifying the color. Further, the color image which is synthesized by the dichroic prism 2112 and which has not yet been projected onto the projection surface S with the projection lens 2114 is hereinafter referred to as an image generated by the liquid crystal panel 100 for the sake of convenience to be distinguished from an image projected onto the projection surface S.

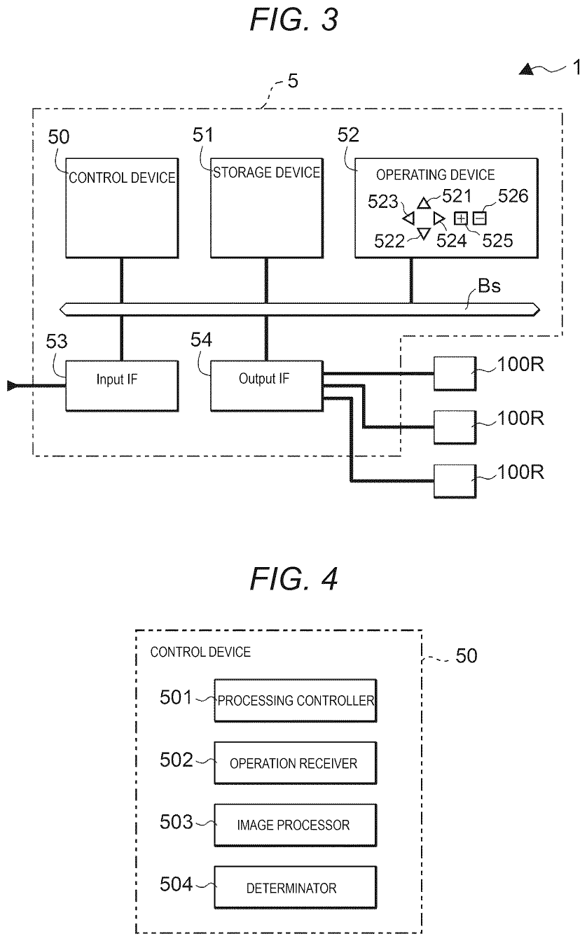

FIG. 3 is a block diagram showing an electrical configuration of the projection display device 1. The projection display device 1 includes a computer 5 in addition to the liquid crystal panels 100R, 100G, and 100B described above. The computer 5 executes the projection method according to the embodiment in cooperation with software.

The computer 5 includes various devices, specifically, a control device 50, a storage device 51, an operating device 52, an input interface (IF) 53, and an output IF 54. These devices are electrically coupled to each other via, for example, a bus Bs.

The projection display device 1 is an example of a “projector” and a “main body”.

The control device 50 is formed of a single processing circuit or a plurality of processing circuits such as central processors (CPU), and integrally controls the elements of the computer 5. Note that the control device 50 may be configured with a circuit such as a digital signal processor (DSP) or an application specific integrated circuit (ASIC) besides the CPU.

The storage device 51 is a single memory device or a plurality of memory devices formed of a known recording medium such as a magnetic recording medium or semiconductor recording medium, and stores programs to be executed by the control device 50, various types of data used by the control device 50, and so on. Further, the storage device 51 is used as a frame memory for temporarily storing the image data input from the host device 3 and a counter for counting the elapsed time.

The storage device 51 may be configured with a combination of a plurality of types of recording media. Further, a portable recording medium that is detachably attached to the computer 5 or an external recording medium, with which the computer 5 can communicate via a communication network, such as an online storage may be used as the storage device 51.

The operating device 52 includes a plurality of operators to be operated by a user, and outputs information corresponding to operations of these operators to the control device 50. In the present embodiment, the operating device 52 includes operators 521 to 526 to be operated by the user. The operators 521 to 524 are arrow keys, and instruct translation or selection of a target element in the arrow direction due to an operation. Particularly, the operators 521 to 524 instruct the translation or the selection of the target element in an upward direction, a downward direction, a leftward direction, and a rightward direction in order due to the operation. Note that as the target elements, there are four vertices of a quadrangle, translation directions of a projection image, and so on as described later.

The operator 525 is a key for designating expansion of the projection image due to the operation. The operator 526 is a key for designating reduction of the projection image due to the operation. The operators 525 and 526 are also used to increase or decrease the length of a period St described later, from an initial setting value (e.g., 1 second). The operators 521 to 526 may be physical keys, or virtual keys that are displayed on-screen or the like. The period St is an example of a “first period”.

The input IF 53 inputs the image data from the host device 3.

The output IF 54 converts the image data corresponding to R out of the image data processed by the control device 50 into an analog data signal with a DA conversion circuit (not shown) and supplies the analog data signal to the liquid crystal panel 100R. Similarly, out of the image data processed by the control device 50, the output IF 54 converts the image data corresponding to G into an analog data signal and then supplies the analog data signal to the liquid crystal panel 100G, converts the image data corresponding to B into an analog data signal and then supplies the analog data signal to the liquid crystal panel 100B.

FIG. 4 is a block diagram illustrating a functional configuration of the control device 50. The control device 50 executes the program stored in the storage device 51 to thereby function as a plurality of elements for processing an image to be projected onto the projection surface S. The plurality of elements is, for example, a processing controller 501, an operation receiver 502, an image processor 503, and a determinator 504.

The processing controller 501 controls the operation receiver 502, the image processor 503, and the determinator 504. Specifically, the processing controller 501 instructs the image processor 503 to perform image processing or instructs the determinator 504 to perform determination in accordance with information received by the operation receiver 502. Further, the processing controller 501 instructs the image processor 503 to perform image processing in accordance with the determination result by the determinator 504.

When the operators 521 to 526 of the operating device 52 are operated by the user, the operation receiver 502 outputs operation information indicating an operation state to the processing controller 501.

The image processor 503 performs processing of generating the projection image on the liquid crystal panel 100, deforming, expanding, reducing, and moving the projection image thus generated in accordance with the control of the processing controller 501.

In response to the instruction of the processing controller 501, the determinator 504 determines the vertex coordinates and so on of the projection image on the liquid crystal panel 100, and then outputs the determination result to the processing controller 501.

As described above, when the projection display device 1 is installed in an inclined state with respect to the projection surface S, the image thus projected is distorted. Since the image data supplied from the host device 3 generally designates a rectangular image, it is necessary to perform adjustment or correction so that the image to be projected becomes rectangular. Examples of such correction or adjustment include optical correction by tilting the optical axis of the projection lens 2114 or the like, but in the present embodiment, digital correction is used. Note that the digital correction means that the image to be drawn on the liquid crystal panel 100 is deformed so as to be, for example,, rectangular when the image represented by the image data supplied from the host device 3 is projected.

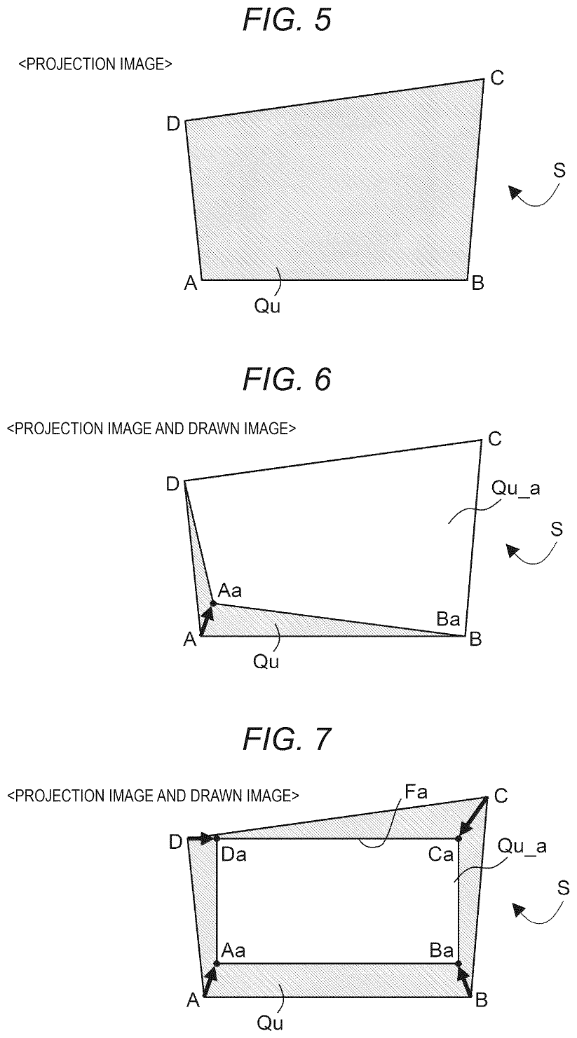

FIG. 5 is a diagram illustrating an example of an image projected with distortion when the projection display device 1 is installed in the state of being inclined with respect to the projection surface S. A distorted quadrangular image projected without correction immediately after the installation is referred to as a drawn image Qu, and four vertices in the drawn image Qu are referred to as A, B, C, and D in order in a counterclockwise direction from the lower left for the sake of convenience. The drawn image Qu on the projection surface S corresponds to an image drawn in the maximum drawing range of the liquid crystal panel 100. An image drawn in the maximum drawing range of the liquid crystal panel 100 is projected onto the projection surface S as the drawn image Qu via the projection lens 2114.

Note that a frame obtained by connecting the vertices A, B, C, and D with straight lines is an outer edge of the drawn image Qu. In other words, the outer edge of the drawn image Qu represents the outline of the outer edge of the liquid crystal panel 100, namely the maximum drawing range in which drawing can be performed on the liquid crystal panel 100, on the projection surface S. The shape of the outer edge of the liquid crystal panel 100 is a rectangle including, as sides, lines each passing through a first element row formed of a plurality of liquid crystal elements arranged outermost in the first direction and arranged in the second direction, and lines each passing through a second element row formed of a plurality of liquid crystal elements arranged outermost in the second direction and arranged in the first direction. Therefore, the shape of the outer edge of the drawn image Qu is rectangular when viewed from the third direction. When the projection display device 1 is installed in a state of being inclined with respect to the projection surface S, the rectangular liquid crystal panel 100 fixed inside the projection display device 1 is also inclined with respect to the projection surface S, and therefore, the entire drawn image Qu is distorted on the projection surface S. Further, the distorted quadrangular shape means a shape in which none of the four vertices is a right angle, and both of pairs of sides opposed to each other are nonparallel to each other.

In the drawn image Qu, in order to project the image represented by the image data on the projection surface S so as to have a rectangular shape, the user operates the operating device 52 to form a desired rectangle within the range of the drawn image Qu in, for example, the following manner.

First, the user designates one of the four vertices in the drawn image Qu.

Specifically, the user selects the vertex A by operating, for example, the operators 521 to 524 and then moves the vertex A to the position of the vertex Aa of the desired rectangle as indicated by the arrow. When the vertex A of the drawn image Qu on the projection surface S is designated and is then moved, the vertex Aa is separated from the vertex A, and the image Qu_a that is quadrangular, and that has the vertices Aa, B, C, and D as shown in FIG. 6 is displayed in a color different from the color of the drawn image Qu.

Similarly, the user performs an operation of moving the vertex B to the position of a vertex Ba, an operation of moving the vertex C to the position of a vertex Ca, and an operation of moving the vertex D to the position of a vertex Da.

It is possible to adopt a configuration in which when an aspect ratio of the image represented by the image data supplied from the host device 3 is determined in advance, at the stage in which the positions of two of the vertices Aa, Ba, Ca, and Da are designated, the other two thereof are moved to the positions determined by that aspect ratio.

Due to such an operation, as shown in FIG. 7, an image Qu_a adjusted to a rectangle is displayed within the range of the drawn image Qu. Note that the image Qu_a is referred to as the projection image in the sense of being distinguished from the drawn image. In addition, a frame connecting the vertices Aa, Ba, Ca, and Da in the projection image Qu_a is referred to as Fa for the sake of convenience. The projection image Qu_a is an image obtained by reducing the drawn image Qu in order to project the image represented by the image data in a rectangular shape onto the projection surface S. The projection image Qu_a is a deformed image obtained by deforming the drawn image Qu in order to project the image represented by the image data in a rectangular shape onto the projection surface S. The projection image Qu_a is projected from the projection display device 1 onto the projection surface S via the projection lens 2114. That is, the projection display device 1 projects the drawn image Qu or the projection image Qu_a onto the projection surface S.

Note that the image represented by the image data supplied from the host device 3 is subjected to the deformation processing by the image processor 503 so as to fit into the projection image Qu_a, and is then displayed. Further, in the drawn image Qu, an area excluding the projection image Qu_a, specifically, the area hatched in FIG. 7, is displayed by the image processor 503 as, for example, an image having a black color, that is, a black image having almost zero brightness on the projection surface S, so as not to interfere with the display of the image represented by the image data. As a result, the hatched area in FIG. 7 is observed from the user such that no image is projected.

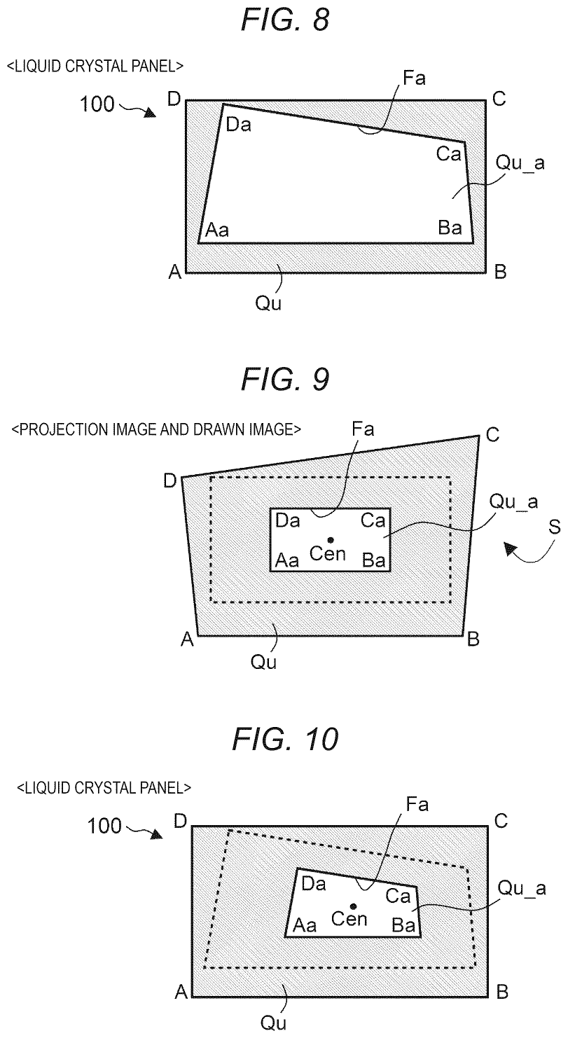

The drawn image Qu and the projection image Qu_a shown in FIG. 7 are the result of projecting the images generated by the liquid crystal panel 100 onto the projection surface S. Conversely, the projection image Qu_a in the liquid crystal panel 100 is generated with the distortion as shown in FIG. 8 in the liquid crystal panel 100 so that the projection image Qu_a actually projected on the projection surface S becomes rectangular.

When the user corrects the drawing position or the like of the projection image Qu_a in the drawn image Qu, it is conceivable that the user temporarily reduces the projection image Qu_a in many cases. This is because the reduction of the projection image Qu_a increases the degree of freedom of translation within the range of the drawn image Qu.

When the user operates the operator 526 that designates reduction in the operating device 52, the image processor 503 reduces the projection image Qu_a in accordance with the period in which the operator 526 is operated with reference to the center Cen of the frame Fa. The projection image Qu_a having been reduced is similar to the projection image Qu_a having not yet been reduced. Note that the center Cen is the diagonal center or the center of gravity of the frame Fa. In addition, “with reference to the center Cen” means that the position of the center Cen before the reduction is fixed even after the reduction.

FIG. 9 is an example in which the projection image Qu_a in the drawn image Qu on the projection surface S is reduced by a similarity ratio of 50%, in other words, by an area ratio of 25%, with respect to the projection image in FIG. 7. Further, FIG. 10 is an example showing the projection image Qu_a in the liquid crystal panel 100 when the drawn image Qu and the projection image Qu_a are projected on the projection surface S as shown in FIG. 9, and is an example in which the projection image represented by a dashed line is reduced with reference to the center Cen at a similarity ratio of 50%.

Note here that the reduction of the projection image Qu_a has been described, but the same applies to the expansion. Particularly, when the user operates the operator 525 that designates the expansion in the operating device 52, the image processor 503 expands the projection image Qu_a in a similar shape in accordance with the period in which the operator 525 is operated with reference to the center Cen of the frame Fa.

However, the projection image Qu_a is generated within the range of the liquid crystal panel 100, and cannot therefore exceed the drawn image Qu when viewed on the projection surface S. Therefore, when the frame Fa of the projection image Qu_a makes contact with the outer edge of the drawn image Qu on the projection surface S due to the expansion, the projection image Qu_a expands while moving along the outer edge of the drawn image Qu, that is, the outer edge of the liquid crystal panel 100, as will be described later.

Note that when the frame Fa of the projection image Qu_a comes into contact with the outer edge of the drawn image Qu due to the expansion means, in other words, when the frame Fa of the projection image Qu_a comes into contact with the outer edge of a display region in the liquid crystal panel 100 in the liquid crystal panel 100.

Then, how the image generated by the liquid crystal panel 100 changes when the projection image Qu_a is moved within the drawn image Qu on the projection surface S will be described.

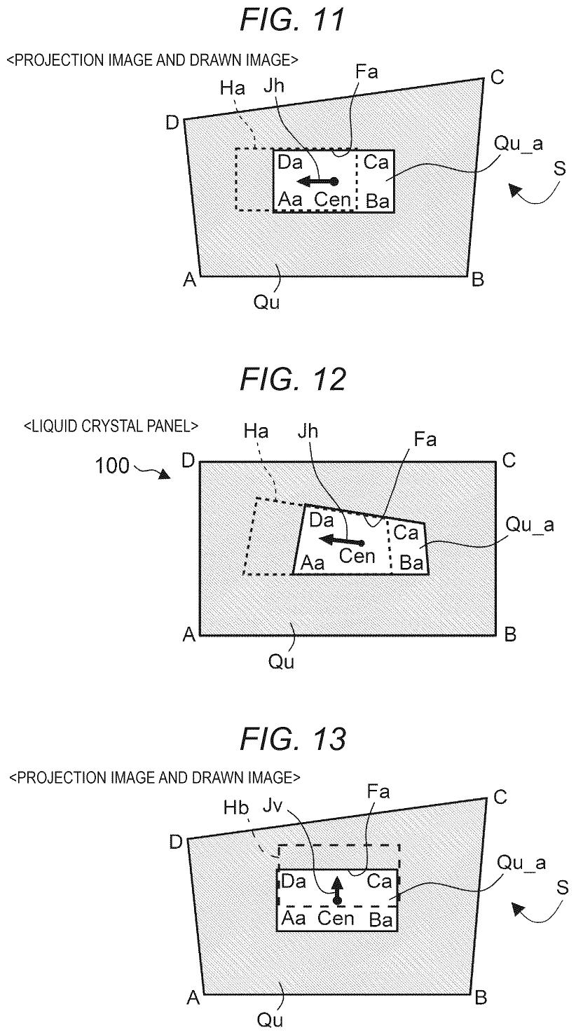

First, when the projection image Qu_a is moved toward the left direction or the right direction will be described. Here, as shown in FIG. 11, there is assumed a state in which the projection image Qu_a having a rectangular shape is projected due to the digital correction on the projection surface S. Note that the projection image Qu_a in FIG. 11 is the same as the projection image Qu_a in FIG. 9.

In this state, when the user operates, for example, the operator 523 means when the user desires to translate the projection image Qu_a adjusted to a rectangle leftward to, for example, the position of the quadrangle Ha represented by a dashed line in FIG. 11.

In the translation in this case, the upper side of the projection image Qu_a moves along an extension line of the straight line from the vertex Ca toward the vertex Da, and the lower side of the projection image Qu_a moves along an extension line of the straight line from the vertex Ba toward the vertex Aa.

Therefore, the translation amount and the translation direction of the projection image Qu_a in this case can be represented by a vector Jh starting from the center Cen in FIG. 11. Note that in FIG. 11, the direction of the vector Jh is the same as the left direction designated by the operator 523.

FIG. 12 is a diagram illustrating how the projection image Qu_a generated by the liquid crystal panel 100 as shown in FIG. 10 moves in what shape.

In the liquid crystal panel 100, the projection image Qu_a moves to a position represented by a quadrangle Ha indicated by a dashed line in FIG. 12. Particularly, in the quadrangle Ha after the translation, the upper side of the projection image Qu_a before the translation moves along the extension line of the straight line from the vertex Ca toward the vertex Da, and the lower side of the projection image Qu_a moves along the extension line of the straight line from the vertex Ba toward the vertex Aa.

Note that in the case of FIG. 12, the projection image having been translated in the leftward direction is a diagram obtained by expanding the projection image Qu_a before the translation in a substantially similar shape.

The translation amount and the translation direction of the projection image Qu_a in the liquid crystal panel 100 are as represented by the vector Jh in FIG. 12. The direction of the vector Jh can be represented by a composite vector of a vector directed from the vertex Ba toward the vertex Aa and a vector directed from the vertex Ca toward the vertex Da, in the translation operation in the leftward direction. The vector Jh represented by the composite vector can be decomposed into a horizontal component and a vertical component in the liquid crystal panel 100. The vector Jh illustrated in FIG. 12 is an example in which the horizontal component in the leftward direction is greater than the vertical component in the upward direction.

The translation in the left direction has been described here, but the same applies to the translation in the right direction. Although not particularly illustrated, in the liquid crystal panel 100, the upper side of the projection image Qu_a moves along an extension line of a straight line from the vertex Da toward the vertex Ca, and the lower side of the projection image Qu_a moves along an extension line of a straight line from the vertex Aa toward the vertex Ba. In the liquid crystal panel 100, the translation direction in the rightward direction is represented by a composite vector of a vector directed from the vertex Da toward the vertex Ca and a vector directed from the vertex Aa toward the vertex Ba. The composite vector is opposite in direction to the vector Jh.

Note that the projection image having been translated in the rightward direction becomes a diagram obtained by reducing the projection image Qu_a that has not been translated and is represented by a solid line in FIG. 12, in a substantially similar shape.

Then, there will be described when the projection image Qu_a is moved in the upward direction or the downward direction.

Here, as shown in FIG. 13, there is assumed the state in which the projection image Qu_a having a rectangular shape is projected on the projection surface S. Note that the projection image Qu_a in FIG. 13 is the same as the projection image Qu_a in FIGS. 9 and 11.

In this state, when the user operates, for example, the operator 521 means when the user desires to translate the projection image Qu_a adjusted to a rectangle to the position of the quadrangle Hb indicated by the dashed line in FIG. 13.

In the translation in this case, the left side of the projection image Qu_a moves along an extension line of a straight line from the vertex Aa toward the vertex Da, and the right side of the projection image Qu_a moves along an extension line of a straight line from the vertex Ba toward the vertex Ca.

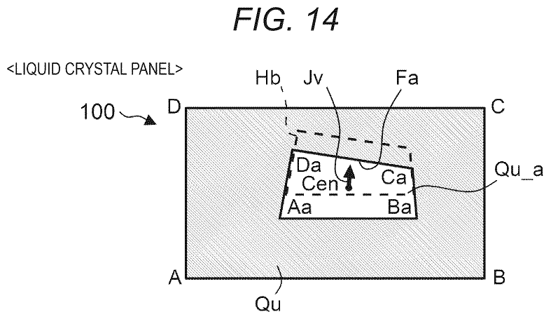

Therefore, the translation amount and the translation direction of the projection image Qu_a in this case can be represented by a vector Jv starting from the center Cen in FIG. 14. Further, the direction of the vector Jv in FIG. 13 is the same as the upward direction designated by the operator 521.

FIG. 14 is a diagram illustrating how the projection image Qu_a generated by the liquid crystal panel 100 as shown in FIG. 13 moves in what shape.

In the liquid crystal panel 100, the projection image Qu_a moves to a position represented by a quadrangle Hb indicated by a dashed line in FIG. 14. Particularly, in the quadrangle Hb having been translated, the left side of the projection image Qu_a before the translation moves along the extension line of the straight line from the vertex Aa toward the vertex Da, and the right side of the projection image Qu_a moves along the extension line of the straight line from the vertex Ba toward the vertex Ca.

Note that, in the case of FIG. 14, the projection image having been translated in the upward direction becomes a diagram obtained by reducing the projection image Qu_a having not been translated in a substantially similar shape.

The translation amount and the translation direction of the projection image Qu_a in the liquid crystal panel 100 are as represented by a vector Jv in FIG. 14. The direction of the vector Jv is represented by a composite vector of a vector directed from the vertex Aa toward the vertex Da and a vector directed from the vertex Ba toward the vertex Ca in the case of the translation operation in the upward direction. The vector Jv represented by the composite vector can be decomposed into a horizontal component and a vertical component in the liquid crystal panel 100. The vector Jv illustrated in FIG. 14 is an example in which the horizontal component in the rightward direction is smaller than the vertical component in the upward direction.

The translation in the upward direction has been described here, but the same applies to the translation in the downward direction. Although not particularly illustrated, in the liquid crystal panel 100, the left side of the projection image Qu_a moves along an extension line of a straight line from the vertex Da toward the vertex Aa, and the right side of the projection image Qu_a moves along an extension line of a straight line from the vertex Ca toward the vertex Ba. In the liquid crystal panel 100, the translation direction in the downward direction is represented by a composite vector of a vector directed from the vertex Da toward the vertex Aa and a vector directed from the vertex Ca toward the vertex Ba. The composite vector is opposite in direction to the vector Jv.

Note that the projection image having been translated in the downward direction is a diagram obtained by expanding the projection image Qu_a that has not been translated, and is represented by a solid line in FIG. 14, in a substantially similar shape.

The reduction and expansion of the projection image Qu_a are as described above.

Then, the operation of the projection method according to the embodiment, specifically, the operation when translating, reducing, or expanding the projection image Qu_a will be described. Note that it is assumed that the projection image Qu_a has already been subjected to the digital correction so as to be rectangular on the projection surface S.

Further, the period St can be changed from the initial setting value by the operator 525 or 526, but in the following, it is assumed that the period St has already been changed from the initial setting value by an operation of the user. Therefore, in the following, it is assumed that the operator 525 designates the expansion of the projection image Qu_a and the operator 526 designates the reduction of the projection image Qu_a.

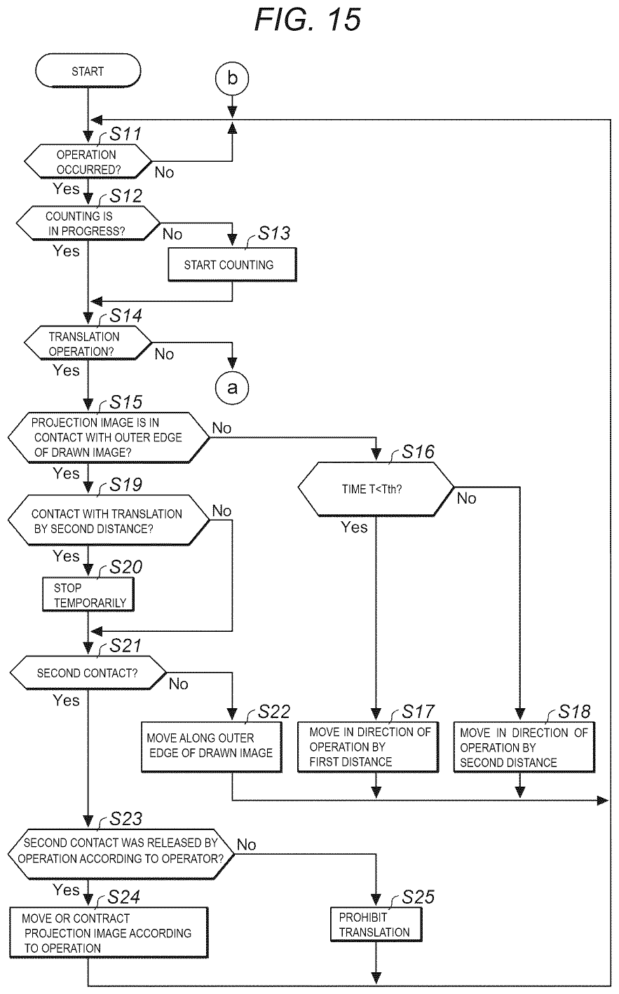

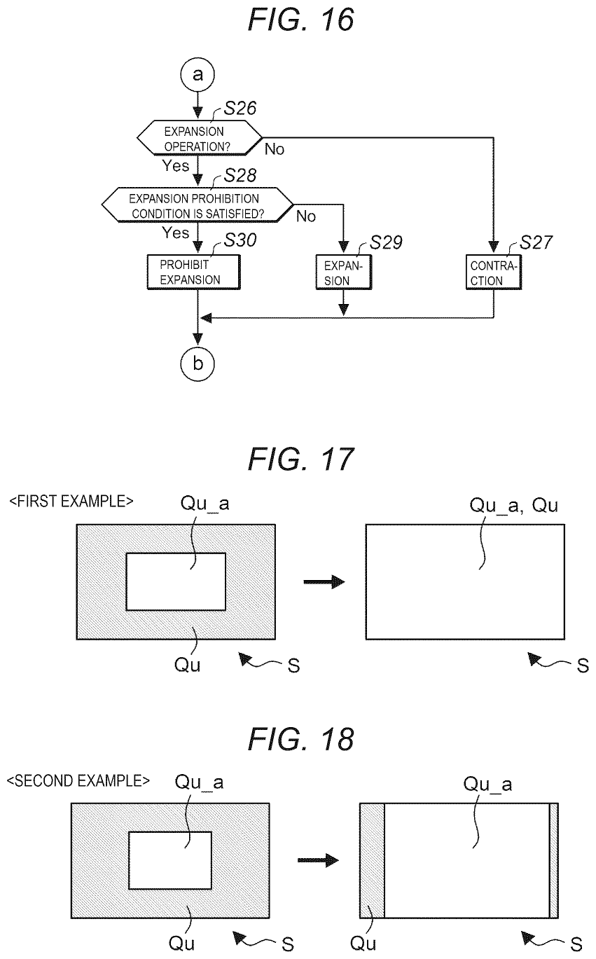

FIG. 15 and FIG. 16 are a flowchart representing the operation of the projection method.

The processing controller 501 repeatedly executes the following steps S11 to S30 at regular time intervals (e.g., every 16.7 milliseconds) except for step S20. This time interval is expressed as a cycle time for the sake of convenience.

First, in step S11, the processing controller 501 determines whether any one of the operators 521 to 526 is operated based on operation information output from the operation receiver 502. When none of the operators 521 to 526 is operated, the determination result in step S11 is “No”, and the processing controller 501 returns the procedure to step S11. In other words, as long as none of the operators 521 to 526 is operated, the procedure only circulates through step S11 at every cycle time.

Although not shown in the drawings, the processing controller 501 makes a counter stop counting when the determination result in step S11 is “No”, and the counter is counting when returning the procedure to step S11.

When any one of the operators 521 to 526 is operated, the determination result in step S11 becomes “Yes”, and the processing controller 501 determines whether the counter is counting in the next step S12.

When the counter is not counting, the determination result in step S12 becomes “No”, and the processing controller 501 resets the counter in step S13, and then makes the counter start counting.

Note that the counter continues to count as long as the determination result continues “Yes” after the determination result changes to “Yes” in step S11. Therefore, time T counted by the counter represents a period during which the operation of the same operator continues as a result.

When the determination result in step S12 is “Yes” or when counting of the counter is started in step S13, the processing controller 501 makes the transition of the procedure to the next step S14.

In step S14, the processing controller 501 determines whether the operator thus operated is any one of the operators 521 to 524. The operator thus operated mentioned here is an operator that serves as a basis for determining that the determination result in step S11 is “Yes”.

When the operator operated is not any one of the operators 521 to 524 that designate the translation of the projection image Qu_a, the operator operated is the operator 525 that designates the expansion of the projection image Qu_a or the operator 526 that designates the reduction thereof. Therefore, the determination result in step S14 becomes “No”, and the processing controller 501 makes the transition of the procedure to step S26 described later.

When the operator operated is any one of the operators 521 to 524 that designate the translation of the projection image Qu_a, the determination result in step S14 becomes “Yes”. When the determination result in step S14 is “Yes”, the processing controller 501 instructs the determinator 504 in step S15 to determine whether the frame Fa of the projection image Qu_a is in contact with the outer edge of the drawn image Qu.

Note that the term “contact” mentioned here does not mean physical contact but means geometric contact between the frame Fa and the outer edge of the drawn image Qu.

The following three aspects are assumed as this contact. That is, there are cited the three aspects namely: one of the vertices of the frame Fa of the projection image Qu_a makes contact with one side in the outer edge of the drawn image Qu; one of the sides of the frame Fa makes contact with one side in the outer edge of the drawn image Qu; and one of the vertices of the frame Fa makes contact with one of the vertices in the outer edge of the drawn image Qu.

The determinator 504 notifies the processing controller 501 of a determination result as to whether it is in contact.

When the notification indicates that there is no contact, that is, when the frame Fa of the projection image Qu_a is not in contact with the outer edge of the drawn image Qu, the determination result in step S15 is “No”. When the determination result in step S15 is “No”, the processing controller 501 determines in step S16 whether the time T counted by the counter is less than the threshold value Tth.

When the time T is less than the threshold value Tth, the determination result in step S16 is “Yes”. When the determination result in step S16 is “Yes”, the processing controller 501 instructs the image processor 503 in step S17 to translate the projection image Qu_a on the liquid crystal panel 100 by a first distance L1 in a direction corresponding to the operator thus operated.

Note that the translation of the projection image Qu_a in the direction thus designated on the projection surface S is a translation in any one of leftward, rightward, upward, and downward directions. In the liquid crystal panel 100, as described above, the direction of the vector Jv corresponds to the upward direction, the opposite direction to the vector Jv corresponds to the downward direction, the leftward direction corresponds to the direction of the vector Jh, and the rightward direction corresponds to the opposite direction to the vector Jh.

In the liquid crystal panel 100, the translation by the first distance means that the projection image Qu_a is translated by the distance obtained by multiplying the magnitude of the vector representing the translation direction by a positive first coefficient in the liquid crystal panel 100.

After the processing in step S17, the processing controller 501 returns the procedure to step S11.

Therefore, when the operation to any one of the operators 521 to 524 continues and the time T in which the operation continues is less than the threshold value Tth, step S17 is repeated every cycle time due to the circulation processing. Therefore, on the projection surface S, the projection image Qu_a moves at a first speed corresponding to the product obtained by multiplying the first distance L1 by the inverse of the cycle time in the operated direction.

Note that the circulation processing described here means that the procedure circulates in a path of steps S11→S12→S14→S15→S16→S17→S11.

When the time T is equal to or longer than the threshold value Tth, the determination result in step S16 is “No”. When the determination result in step S16 is “No”, the processing controller 501 instructs the image processor 503 in step S18 to translate the projection image Qu_a on the liquid crystal panel 100 by a second distance L2 in a direction corresponding to the operator thus operated.

In the liquid crystal panel 100, the translation by the second distance means that the projection image Qu_a is translated by the distance obtained by multiplying the magnitude of the vector representing the t translation direction by a second coefficient in the liquid crystal panel 100. Here, the second coefficient is larger than the first coefficient.

That is, the first distance L1 and the second distance L2 have the following relationship.

L1<L2

Note that after the processing in step S18, the processing controller 501 returns the procedure to step S11.

Therefore, when the operation to any one of the operators 521 to 524 continues and the time T in which the operation continues is no less than the threshold value Tth, step S18 is repeated every cycle time due to the circulation processing. Therefore, on the projection surface S, the projection image Qu_a moves at a second speed corresponding to the product obtained by multiplying the second distance L2 by the inverse of the cycle time in the operated direction.

In other words, when the time T in which the same operator is continuously operated becomes equal to or longer than the threshold value Tth, the distance per unit time at which the projection image Qu_a moves changes from L1 to L2 to thereby be longer, and therefore, the moving speed of the projection image Qu_a increases from the first speed to the second speed as a result.

Note that the circulation processing described here means that the procedure circulates in a path of steps S11→S12→S14→S15→S16→S18→S11.

Meanwhile, when the processing controller 501 receives, from the determinator 504, a notification that the contact occurs in response to the instruction to the determinator 504 in step S15, the determination result in step S15 becomes “Yes”. That is, the frame Fa of the projection image Qu_a is in contact with the outer edge of the drawn image Qu.

When the determination result in step S15 is “Yes”, the processing controller 501 determines in step S19 whether the contact is a contact resulting from the translation by the second distance L2, that is, a contact resulting from the translation at the second speed.

When the contact is not the contact resulting from the translation at the second speed, the determination result in step S19 is “No”, and the processing controller 501 skips step S20, and makes the transition of the procedure to step S21.

On the other hand, when the contact is the contact resulting from the translation at the second speed, the determination result in step S19 becomes “Yes”, and the processing controller 501 makes the image processor 503 stop the projection image Qu_a at a point where the projection image Qu_a comes into contact with the outer frame of the drawn image Qu for a period St set in advance in step S20. That is, in step S20, the processing is paused for the period St.

When the period St has elapsed or when the determination result in step S19 is “No”, the processing controller 501 instructs the determinator 504 in step S21 to determine whether the contact due to the translation on the basis that the determination result in step S15 becomes “Yes” is the second contact. The determinator 504 notifies the processing controller 501 of the determination result as to whether the second contact has occurred.

In the present embodiment, three cases are assumed in which the contact caused by the translation is the second contact.

The first case is that, in a state in which one of the vertices in the frame Fa of the projection image Qu_a is in contact with one side in the outer edge of the drawn image Qu, another of the vertices in the frame Fa is in contact with another side in the outer edge of the drawn image Qu. The second case is that one side of the frame Fa of the projection image Qu_a comes into contact with one side in the outer edge of the drawn image Qu. The third case is that one of the vertices in the frame Fa of the projection image Qu_a comes into contact with one of the vertices in the outer edge of the drawn image Qu.

When the notification that it is not the second contact is made, the determination result in step S21 is “No”. When the determination result in step S21 is “No”, the processing controller 501 instructs the image processor 503 in step S22 to translate the projection image Qu_a in a direction along the outer edge and reflecting the operation direction in a state where the projection image Qu_a is in contact with the outer edge of the drawn image Qu.

Here, the direction along the outer edge and reflecting the operation direction means a direction reflecting the translation direction designated by the operator among the two directions along the outer edge when the projection image Qu_a comes into contact with the outer edge of the drawn image Qu when viewed on the projection surface S. Particularly, it is a direction that can be represented by a composite vector of a vector in a translation direction designated by an operator and a vector in a direction orthogonal to the translation direction, out of the two directions along the outer edge.

For example, when the operator 523 is operated, the projection image Qu_a moves in the leftward direction indicated by the vector Jh in FIG. 11 on the projection surface S. When the operator 523 continues to be operated, the vertex Aa of the frame Fa of the projection image Qu_a comes into contact with the side connecting the vertices A and D of the outer edge of the drawn image Qu. As the direction along the side, there are two directions, namely a direction from the vertex A to the vertex D, and a direction from the vertex D to the vertex A on the contrary. Out of these two directions, the direction that can be represented by the composite vector of a vector in the leftward direction designated by the operator 523 and a vector in a direction orthogonal to that vector in the leftward direction is the direction from the vertex A to the vertex D. Therefore, by the operation of the operator 523, the vertex Aa of the frame Fa of the projection image Qu_a comes into contact with the side connecting the vertices A and D out of the outer edge of the drawn image Qu on the projection surface S, and then moves in the direction from the vertex A to the vertex D.

When viewed in the liquid crystal panel 100, when the vertex Aa comes into contact with the outer edge of the liquid crystal panel 100, the angle formed of the vertices D, Aa, and Da is smaller than the angle formed of the vertices A, Aa, and Ba. Therefore, the vertex Aa having contact with the outer edge of the liquid crystal panel 100 moves in the direction from the vertex A to the vertex D, that is, in the upward direction, along the side connected by the vertices A and D having the smaller angle.

Further, for example, when the operator 521 is operated, the projection image Qu_a moves in the upward direction indicated by the vector Jv in FIG. 13 on the projection surface S. When the operator 521 continues to be operated, the vertex Da of the frame Fa of the projection image Qu_a comes into contact with the side connecting the vertices C and D out of the outer edge of the drawn image Qu. As the direction along the side, there are two directions, namely a direction from the vertex C to the vertex D, and a direction from the vertex D to the vertex C on the contrary. Out of these two directions, the direction that can be represented by the composite vector of the vector in the upward direction designated by the operator 521 and the vector in a direction orthogonal to that vector in the upward direction is the direction from the vertex D to the vertex C. Therefore, by the operation of the operator 521, the vertex Da of the frame Fa of the projection image Qu_a comes into contact with the side connecting the vertices C and D out of the outer edge of the drawn image Qu on the projection surface S, and then moves in the direction from the vertex D to the vertex C.

When viewed in the liquid crystal panel 100, when the vertex Da comes into contact with the outer edge of the liquid crystal panel 100, the angle formed of the vertices C, Da, and Ca is smaller than the angle formed of the vertices D, Da, and Aa. Therefore, the vertex Da having contact with the outer edge of the liquid crystal panel 100 moves in the direction from the vertex D to the vertex C, that is, in the rightward direction, along the side connected by the vertices D and C having the smaller angle.

After the processing in step S22, the processing controller 501 returns the procedure to step S11.

On the other hand, when the notification that it is the second contact is made, the determination result in step S21 is “Yes”. When the determination result in step S21 is “Yes”, the processing controller 501 makes the determinator 504 determine the next content in step S23. That is, in step S23, the processing controller 501 makes the determinator 504 determine whether the second contact state is released by the operator currently operated in the projection image Qu_a that is in the second contact state.

The release of the second contact state means that when the projection image Qu_a moves in accordance with the operator operated, the second contact state does not correspond to any of the first, second, and third cases.

For example, it can be cited that the operator 524 is operated to instruct the translation of the projection image Qu_a in the rightward direction, and that the operator 522 is operated to instruct the translation of the projection image Qu_a in the downward direction when the projection image Qu_a is located at the upper left end of the drawn image Qu and is in the second contact state.

Note that the second contact state is also released by the reduction of the projection image Qu_a, but the reduction is instructed by the operation with the operator 526 (since the determination result in step S14 which is a premise becomes “No”), and therefore, it is not the target of the determination in step S23.

When the notification that it is an operation for releasing the second contact state is made, the determination result in step S23 is “Yes”. When the determination result in step S23 is “Yes”, the processing controller 501 instructs the image processor 503 in step S24 to move or reduce the projection image Qu_a in accordance with that operation.

After the processing in step S24, the processing controller 501 returns the procedure to step S11.

When the notification that it is not the operation for releasing the second contact state is made, the determination result in step S23 is “No”. When the determination result in step S23 is “No”, the processing controller 501 instructs the image processor 503 in step S25 to prohibit the translation of the projection image Qu_a regardless of the operation of the operator.

After the processing in step S25, the processing controller 501 returns the procedure to step S11.

Note that when the operator, that has been operated before the second contact is made, continues to be operated when the procedure has returned to step S11, the projection image Qu_a stops at the second contact point due to step S25. In contrast, when another operator is operated so that the second contact of the projection image Qu_a is released when the procedure has returned to step S11, processing corresponding to the operation of the another operator is executed.

Incidentally, when the operator operated in step S11 is the operator 525 that designates the expansion of the projection image Qu_a or the operator 526 that designates the reduction, the determination result in step S14 becomes “No”.

When the determination result in step S14 is “No”, the processing controller 501 determines in step S26 in FIG. 16 whether the operator operated was the operator 525 that designates the expansion of the projection image Qu_a. Note that the operator operated mentioned here is an operator on which the determination is made to obtain the determination result of “Yes” in step S11.

When the operator operated was not the operator 525, the operator operated was the operator 526 that designates the reduction of the projection image Qu_a, and the determination result in step S26 is “No”.

When the determination result in step S26 is “No”, the processing controller 501 instructs the image processor 503 in step S27 to reduce the projection image Qu_a at the present time to a predetermined magnification (e.g., 98% with respect to the original figure) in a similar shape with reference to the center Cen. With this instruction, the image processor 503 actually reduces the projection image Qu_a in accordance with the instruction.

After the processing in step S27, the processing controller 501 returns the procedure to step S11.

Note that when the operation on the operator 526 continues, step S25 is repeated every cycle time due to the circulation processing. Therefore, on the projection surface S, the projection image Qu_a continues to be reduced with reference to the center Cen. The circulation processing described here means that the procedure circulates in a path of steps S11→S12→S14→S26→S27→S11.

However, when the operation to the operator 526 continues and the projection image Qu_a continues to be reduced, the projection image Qu_a becomes a minute point and cannot be recognized by the user, and therefore, it is possible to adopt a configuration in which, for example, there is prohibited the reduction in which the area of the projection image Qu_a is reduced at a predetermined ratio with respect to the area of the liquid crystal panel 100.

When the operator operated is the operator 525 that designates the expansion of the projection image Qu_a, the determination result in step S26 is “Yes”. When the determination result in step S26 is “Yes”, the processing controller 501 inquires of the determinator 504 in step S28 whether an expansion prohibition condition of the projection image Qu_a is satisfied at the present time. Here, the expansion prohibition condition of the projection image Qu_a means a state in which the projection image Qu_a cannot be expanded any more in the drawn image Qu. As a typical case in which the expansion prohibition condition is satisfied, there can be cited that the three vertices in the frame Fa of the projection image Qu_a are in contact with the outer edge of the drawn image Qu. Other cases in the expansion prohibition condition of the projection image Qu_a will be described later.

When the expansion prohibition condition is not satisfied as a result of the inquiry to the determinator 504, the determination result in step S28 is “No”.

When the determination result in step S28 is “No”, the processing controller 501 instructs the image processor 503 in step S29 to expand the projection image Qu_a at the present time to, for example, a predetermined magnification (e.g., 102% with respect to the original figure) in a similar shape.

When the vertex of the projection image Qu_a comes into contact with the outer edge of the drawn image Qu due to this expansion, the image processor 503 expands the projection image Qu_a while moving the vertex of the projection image Qu_a along the outer edge of the drawn image Qu. Therefore, the expansion with reference to the center Cen is not achieved in some cases.

After the processing in step S29, the processing controller 501 returns the procedure to step S11.

When the expansion prohibition condition is satisfied as a result of the inquiry to the determinator 504, the determination result in step S28 is “Yes”.

When the determination result in step S28 is “Yes”, the processing controller 501 instructs the image processor 503 in step S30 to prohibit the expansion of the projection image Qu_a.

After the processing in step S30, the processing controller 501 returns the procedure to step S11.

When the operator 525 is continuously operated when the procedure returns to step S11, the projection image Qu_a is not expanded due to step S30. On the other hand, when an operation is performed such that the expansion prohibition condition is not satisfied when the procedure returns to step S11, for example, when the operator 526 is operated, the projection image Qu_a is reduced.

Here, examples of the expansion prohibition condition of the projection image Qu_a will be described. FIG. 17 to FIG. 24 are diagrams illustrating the examples of the expansion prohibition condition of the projection image Qu_a with respect to the drawn image Qu.

Note that the description will be presented here assuming that the projection image Qu_a is in a state of being subjected to the digital correction into a rectangular shape on the projection surface S.

A first example illustrated in FIG. 17 is when the drawn image Qu is a rectangle when viewed on the projection surface S, and when the aspect ratio of the drawn image Qu and the aspect ratio of the projection image Qu_a coincide with each other. The expansion prohibition condition in this case is that the four vertices of the projection image Qu_a coincide with the four vertices of the drawn image Qu, respectively. In this case, regarding the expansion prohibition condition from a viewpoint of the liquid crystal panel 100, it is also required for the four vertices of the projection image Qu_a as a rectangle to respectively coincide with the four vertices of the liquid crystal panel 100.

A second example illustrated in FIG. 18 is when the drawn image Qu is a rectangle when viewed on the projection surface S, but the aspect ratio of the drawn image Qu fails to coincide with the aspect ratio of the projection image Qu_a. The expansion prohibition condition in this case is that two sides opposed to each other in the projection image Qu_a come into contact with two sides opposed to each other of the drawn image Qu. In this case, the expansion prohibition condition from a viewpoint of the liquid crystal panel 100 is that the two sides opposed to each other in the projection image Qu_a as a rectangle come into contact with the two sides opposed to each other in the liquid crystal panel 100, respectively.

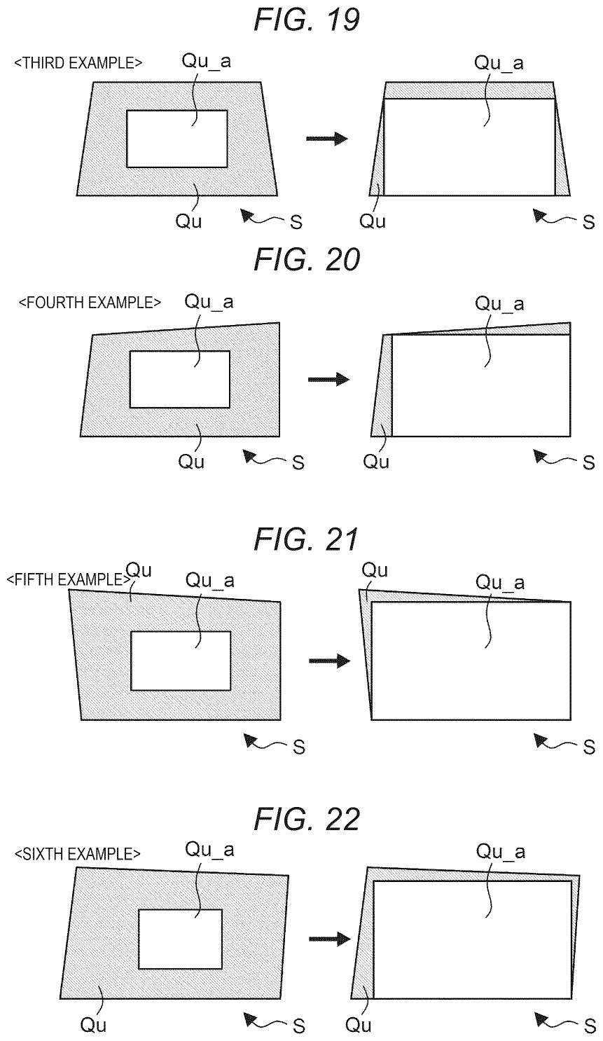

A third example illustrated in FIG. 19 is when the drawn image Qu is a trapezoid when viewed on the projection surface S. The expansion prohibition condition in this case is that one side of the projection image Qu_a comes into contact with one of two sides parallel to each other in the drawn image Qu, and two of the vertices of the projection image Qu_a come into contact with two sides non-parallel to each other in the drawn image Qu. In this case, in the liquid crystal panel 100, the projection image Qu_a has a trapezoidal shape. Therefore, the expansion prohibition condition from a viewpoint of the liquid crystal panel 100 is that one of two sides parallel to each other of the projection image Qu_a has contact with one side of the liquid crystal panel 100, and two vertices at both ends of the other of the two sides parallel to each other of the projection image Qu_a have contact with two sides in the liquid crystal panel 100.

A fourth example illustrated in FIG. 20 and a fifth example illustrated in FIG. 21 are when the drawn image Qu is a quadrangle when viewed on the projection surface S, and one of the four vertices is a right angle. However, in this case, it is almost impossible for the drawn image Qu to be projected in that shape in view of the installation state of the projection display device 1 although it is possible from a geometrical point of view.

A sixth example illustrated in FIG. 22 is when the drawn image Qu is a distorted quadrangle viewed on the projection surface S, and when one side of the drawn image Qu and one side of the projection image Qu_a are parallel to each other. The expansion prohibition condition in this case from a viewpoint of the projection surface S is that the one side of the projection image Qu_a and the one side of the drawn image Qu parallel to each other come into contact with each other, and one of the vertices of the projection image Qu_a comes into contact with any one of the four sides of the drawn image Qu. In this case, the expansion prohibition condition from a viewpoint of the liquid crystal panel 100 is that, similarly to the projection surface S, the one side of the projection image Qu_a and the one side of the drawn image Qu parallel to each other come into contact with each other, and one of the vertices of the projection image Qu_a comes into contact with any one of the four sides of the liquid crystal panel 100.

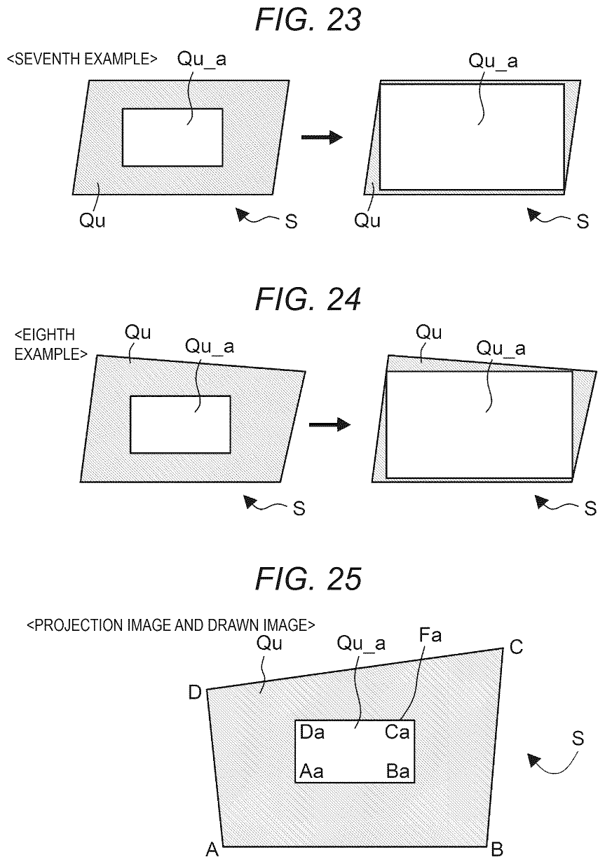

A seventh example illustrated in FIG. 23 is when the drawn image Qu is a parallelogram when viewed on the projection surface S. However, it is almost impossible for the drawn image Qu to be projected in the parallelogram in the projection display device 1 although it is possible for the drawn image Qu projected on the projection surface S to become the parallelogram from a geometrical point of view.

An eighth example illustrated in FIG. 24 is when the drawn image Qu is a distorted quadrangle viewed on the projection surface S. In this case, the expansion prohibition condition from a viewpoint of the projection surface S is the typical case described above, in which three of the vertices of the projection image Qu_a are in contact with any three sides of the drawn image Qu. The expansion prohibition condition in this case from a viewpoint of the liquid crystal panel 100 is that the three vertices of the projection image Qu_a come into contact with three sides of the outer edge in the liquid crystal panel 100.

As described above, there are five cases in which the expansion prohibition condition in the present embodiment is satisfied, namely the first example, the second example, the third example, the sixth example, and the eighth example.

Then, how the display of the projection image Qu_a changes when the user actually operates the operators 521 to 526 will specifically be described with reference to the flowchart described above. Note that it is assumed that the projection image Qu_a has already been digitally corrected on the projection surface S. That is, as shown in FIG. 25, the projection image Qu_a is digitally corrected into a rectangle in the drawn image Qu having a distorted quadrangular shape on the projection surface S.

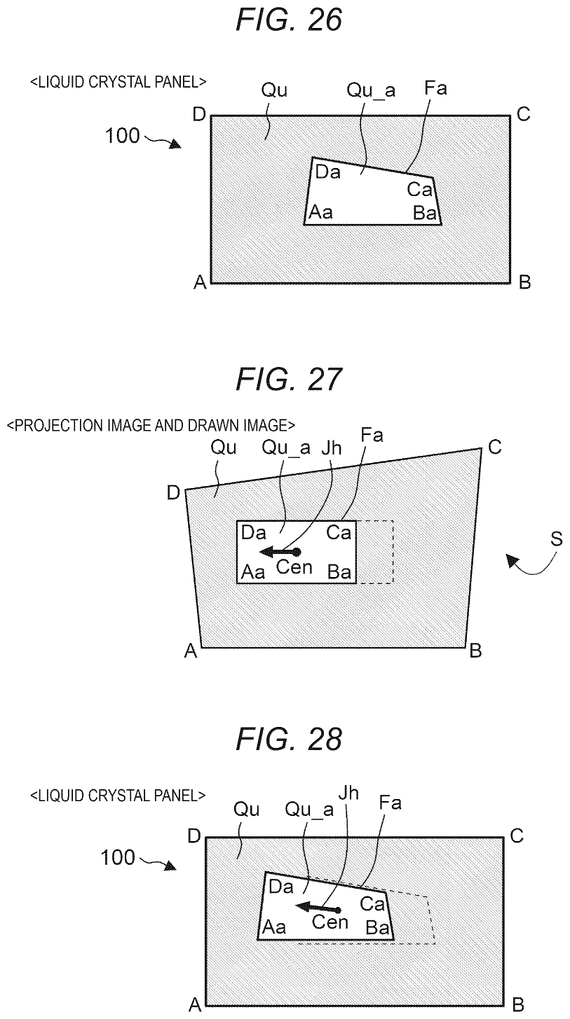

As shown in FIG. 25, when the drawn image Qu and the projection image Qu_a are projected on the projection surface S, the projection image Qu_a is generated in the liquid crystal panel 100 in the shape shown in FIG. 26.

It is assumed that, for example, the user operates in this state the operator 523 that designates the translation of the projection image Qu_a in the leftward direction. Due to this operation, the processing procedure proceeds to steps S11, S12, and S13, and the time T from the start of the operation of the operator 523 is counted.

In a state where the frame Fa of the projection image Qu_a does not have contact with the outer edge of the drawn image Qu and the time T is less than the threshold value Tth while the operation on the operator 523 is continuing, the processing procedure proceeds in the order of steps S14, S15, S16 and S17, and therefore, the projection image Qu_a moves leftward by the first distance L1 on the projection surface S. As long as that state continues, steps S11, S14, S15, S16 and S17 are repeatedly executed every cycle time in the processing procedure, and therefore, the projection image Qu_a moves leftward on the projection surface S at the first speed based on the first distance L1.

Note that the first speed is represented by a product obtained by multiplying the first distance L1 by the inverse of the cycle time.

FIG. 27 is a diagram illustrating a state in which the projection image Qu_a is moved leftward on the projection surface S from the state with the dashed line to the state with the solid line when step S17 is repeated a plurality of times. Further, as shown in FIG. 27, when the projection image Qu_a moves leftward on the projection surface S with respect to the drawn image Qu, the projection image Qu_a moves in the direction of the vector Jh in the liquid crystal panel 100 while deforming in a substantially similar shape with respect to the figure that has not been translated and is represented by the dashed line as shown in FIG. 28.

When the frame Fa of the projection image Qu_a does not make contact with the outer edge of the drawn image Qu and the time T becomes equal to or longer than the threshold value Tth while the operation on the operator 523 is continuing, the processing procedure proceeds to steps S14, S15, S16, and S18, and therefore, a distance of the translation in the leftward direction of the projection image Qu_a on the projection surface S changes from the first distance L1 to the second distance L2.

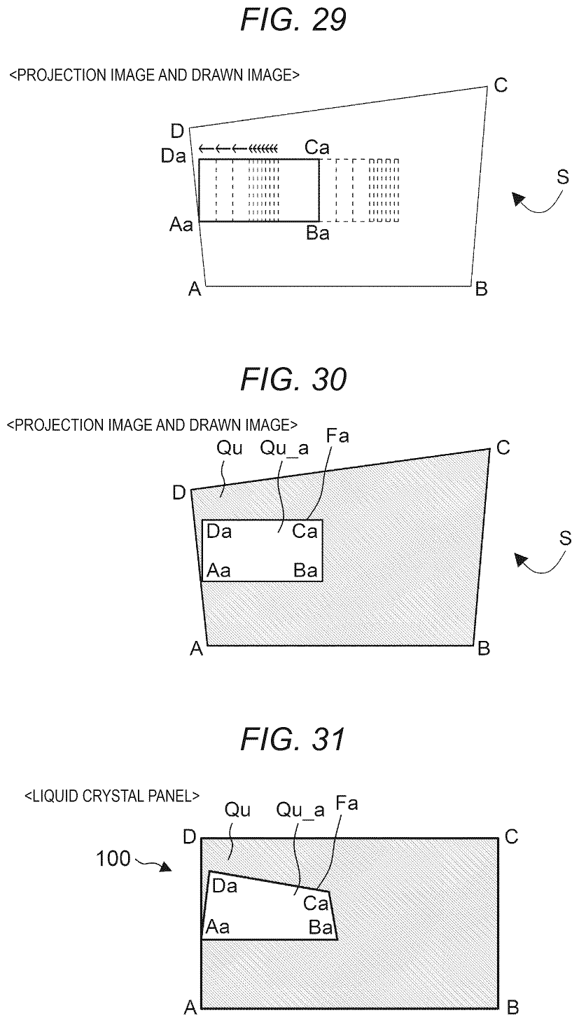

Since L1<L2 is true, as long as the operation on the operator 523 continues, the projection image Qu_a moves leftward at the second speed higher than the first speed on the projection surface S until the frame Fa of the projection image Qu_a makes contact with the outer edge of the drawn image Qu as shown in FIG. 29.

Note that the dashed lines in FIG. 29 each represent a position at every cycle time in the frame Fa of the projection image Qu_a, and the arrows each represent a moving distance in every cycle time.

When the frame Fa of the projection image Qu_a makes contact with the outer edge of the drawn image Qu at the second speed while the operation on the operator 523 is continuing, the processing procedure proceeds to step S20, and therefore, after the projection image Qu_a temporarily stops in a state of being in contact with the outer edge of the drawn image Qu, the processing procedure makes the transition to step S21.

Further, when the frame Fa of the projection image Qu_a makes contact with the outer edge of the drawn image Qu at the first speed, the processing procedure skips step S20 to cause the transition to step S21. Since the contact described here is the first contact, the processing procedure makes the transition to step S22. Due to step S22, the projection image Qu_a moves along the outer edge of the drawn image Qu.

FIG. 30 is a diagram showing a state in which the vertex Aa in the frame Fa of the projection image Qu_a is in contact with the outer edge of the drawn image Qu, particularly, the side connecting the vertices A and D to each other, on the projection surface S due to the continuation of the operation on the operator 521. As shown in the drawing, when the frame Fa of the projection image Qu_a makes contact with the outer edge of the drawn image Qu, the projection image Qu_a is generated in the liquid crystal panel 100 as shown in FIG. 31.

At the vertex Aa in contact with the outer edge of the liquid crystal panel 100, the angle formed of the vertices D, Aa, and Da is smaller than the angle formed of the vertices A, Aa, and Ba. Therefore, in the liquid crystal panel 100, the vertex Aa moves toward the vertex D smaller in angle, that is, along the upward direction.

As described above, when the operation of the operator 523 continues even after the contact, in the liquid crystal panel 100, the vertex Aa of the projection image Qu_a moves in the upward direction from the vertex A toward the vertex D along the side that the vertex Aa has contact with out of the outer edge of the drawn image Qu, that is, the side connecting the vertex A and the vertex D as shown in FIG. 33. Note that speed of this translation may be kept in the first speed or the second speed before contact, or may be a third speed lower than the first speed.

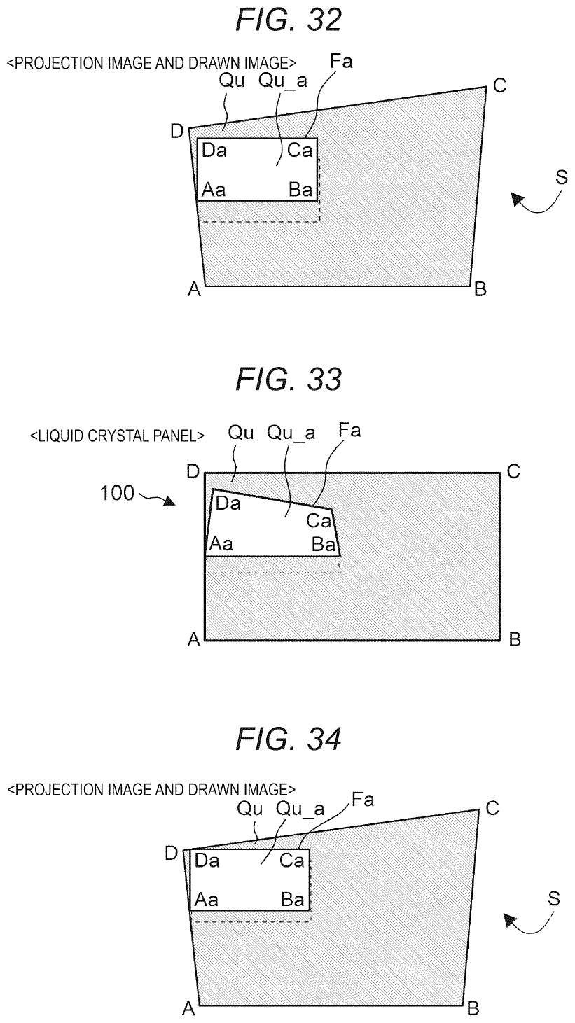

After the contact, by the projection image Qu_a moving as shown in FIG. 33 in the liquid crystal panel 100, it is visually recognized that the vertex Aa of the projection image Qu_a moves in the direction from the vertex A to the vertex D along the outer edge of the drawn image Qu_as shown in FIG. 32 in the projection surface S.

FIG. 34 is a diagram illustrating a state in which the second contact occurs on the projection surface S. Particularly, that drawing is a diagram showing a state in which the vertex Da in the frame Fa comes into contact with the side connecting the vertices C and D out of the outer edge of the drawn image Qu as a result of the translation of the vertex Aa in the frame Fa of the projection image Qu_a in the direction from the vertex A to the vertex D in the state of keeping contact with the outer edge of the drawn image Qu after the first contact.

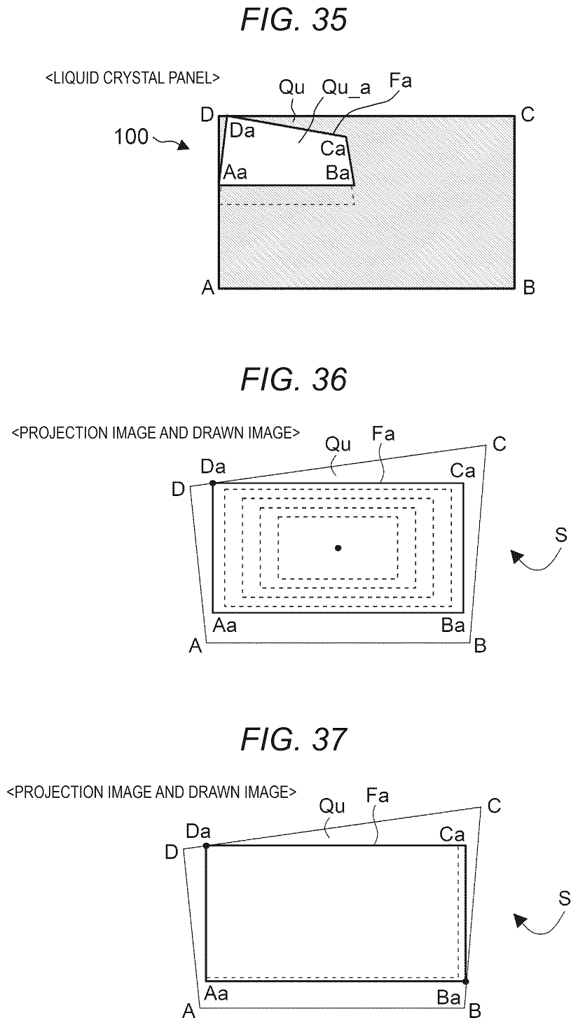

As shown in the drawing, when the second contact occurs on the projection surface S, the projection image Qu_a is generated as shown in FIG. 35 in the liquid crystal panel 100.

When the second contact occurs and the operator 523 is still operated, the projection image Qu_a cannot move in accordance with that operator, and therefore the translation of the projection image Qu_a is prohibited in step S25. Therefore, even when the operation on the operator 523 continues, the projection image Qu_a stops at the position shown in FIG. 34 when viewed on the projection surface S and at the position shown in FIG. 35 when viewed in the liquid crystal panel 100.

Note that, when the projection image Qu_a stops at the position shown in FIG. 34 or FIG. 35, even when the other operator 521 is operated, the projection image Qu_a cannot move in the upward direction designated by that operator 521, and thus the prohibition of the translation continues.

On the other hand, when the operator 522 is operated, the projection image Qu_a can move in the downward direction designated by that operator 522. Therefore, in step S24, the projection image Qu_a moves in accordance with the operation on the operator 522. Similarly, when the operator 524 is operated, the projection image Qu_a can move in the rightward direction designated by the operator 524. Therefore, in step S24, the translation occurs in accordance with the operation on the operator 524.

Note that the description is presented here citing when the translation before the contact is in the leftward direction as an example, but the same applies to the translation in the rightward direction. Although not particularly shown in the drawings, when the projection image Qu_a moves in the rightward direction from the position shown in FIG. 26, the vertex Ba comes into contact with the outer edge of the liquid crystal panel 100. When the vertex Ba comes into contact with the outer edge of the liquid crystal panel 100, the angle formed of the vertices C, Ba, and Ca is smaller than the angle formed of the vertices B, Ba, and Aa. Therefore, in the liquid crystal panel 100, the vertex Ba moves toward the vertex C, that is, in the upward direction along the side connecting the vertices B and C.

Then, how the display of the projection image Qu_a changes when the user actually operates the operator 525 that designates expansion will specifically be described with reference to the flowchart described above. Note that it is assumed here that the drawn image Qu is a quadrangle distorted as shown in FIG. 25 on the projection surface S, and the projection image Qu_a is digitally corrected into a rectangle in the drawn image Qu. As shown in FIG. 25, when the drawn image Qu and the projection image Qu_a are projected on the projection surface S, the projection image Qu_a is generated in the liquid crystal panel 100 in the shape shown in FIG. 26.

In this state, it is assumed that the user operates the operator 525 that designates the expansion of the projection image Qu_a, for example. Due to this operation, the processing procedure proceeds to steps S11, S12, S14, S26, and S28.

When the operation on the operator 525 continues, in a state in which the frame Fa of the projection image Qu_a does not come into contact with the outer edge of the drawn image Qu, the processing procedure proceeds to step S29, and therefore, the projection image Qu_a is expanded by a predetermined magnification in a similar shape with reference to the center Cen on the projection surface S. Until the operation on the operator 525 continues and a contact with the outer edge occurs, steps S11, S12, S14, S26, S28 and S29 are repeatedly executed every cycle time in the processing procedure.

FIG. 36 is a diagram illustrating a state in which the projection image Qu_a is expanded at a predetermined magnification until the frame Fa of the projection image Qu_a comes into contact with the outer edge of the drawn image Qu on the projection surface S. Note that dashed lines in FIG. 36 each represent a position at each cycle time in the frame Fa of the projection image Qu_a.

When the operation on the operator 525 continues, the frame Fa of the projection image Qu_a eventually comes into contact with the outer edge of the drawn image Qu.

The projection image Qu_a represented by a solid line in FIG. 36 is a diagram showing a state in which the vertex Da in the frame Fa of the projection image Qu_a is in contact with the outer edge of the drawn image Qu, particularly, the side connecting the vertices C and D, on the projection surface S due to the operation on the operator 525 continued.

Note that on the projection surface S, even when one vertex in the frame Fa of the projection image Qu_a makes contact with the outer edge of the drawn image Qu, the expansion prohibition condition is not satisfied. Therefore, the projection image Qu_a continues to be expanded due to the repetition of step S29.

However, in the state in which one vertex in the frame Fa of the projection image Qu_a is in contact with one side in the outer edge of the drawn image Qu, the expansion based on the center Cen cannot be performed, and therefore, the expansion reference is changed to, for example, the vertex in contact with the one side in the outer edge of the drawn image Qu. In the example of FIG. 36, when the vertex Da in the frame Fa of the projection image Qu_a comes into contact with the side connecting the vertices C and D in the outer edge of the drawn image Qu, the expansion reference is changed to the vertex Da.

When the operation on the operator 525 still continues, another vertex in the frame Fa of the projection image Qu_a eventually comes into contact with the outer edge of the drawn image Qu.

FIG. 37 is a diagram showing a state in which another vertex Ba is in contact with a side connecting the vertices B and C when the operation on the operator 525 continues and thus the expansion occurs with reference to the vertex Da in the frame Fa of the projection image Qu_a on the projection surface S. Note that a dashed line in FIG. 37 represents the projection image Qu_a with a solid line in FIG. 36, that is, the state in which the vertex Da is in contact with the side connecting the vertices C and D in the outer edge of the drawn image Qu.

Note that even when the two vertices of the projection image Qu_a come into contact with the outer edge of the drawn image Qu, the expansion prohibition condition is not satisfied.

Therefore, the projection image Qu_a continues to be expanded due to the repetition of step S29.

However, in the state in which the two vertices in the frame Fa of the projection image Qu_a are in contact with the outer edge of the drawn image Qu, the expansion based on either one of the two vertices cannot be achieved. Therefore, the projection image Qu_a is expanded under the condition that the two vertices in the frame Fa of the projection image Qu_a are located on the outer edge of the drawn image Qu.

When the operation on the operator 525 still continues, still another vertex in the frame Fa of the projection image Qu_a eventually comes into contact with the outer edge of the drawn image Qu.

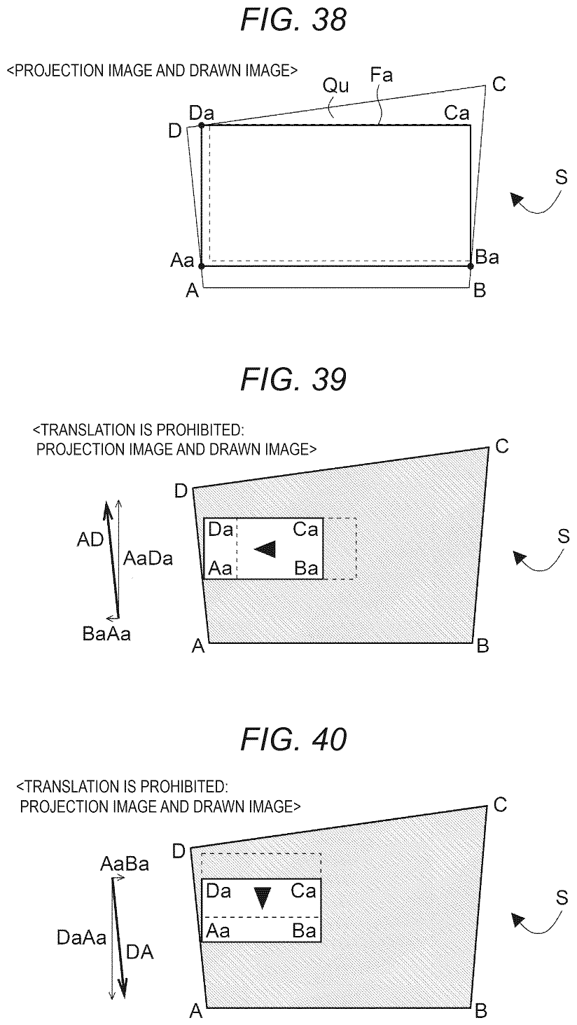

FIG. 38 is a diagram showing a state in which, due to the operation on the operator 525 being continued, in addition to the vertices Da and Ba in the frame Fa of the projection image Qu_a, another vertex Aa is in contact with the side connecting the vertices A and D on the projection surface S. Note that a dashed line in FIG. 38 represents the projection image Qu_a with a solid line in FIG. 37, that is, a state in which the vertices Da and Ba are in contact with the outer edge of the drawn image Qu.

When the three vertices of the projection image Qu_a each come into contact with the outer edge of the drawn image Qu, the expansion prohibition condition is satisfied. Therefore, in step S30, the expansion of the projection image Qu_a is prohibited.

The state in which the expansion prohibition condition is satisfied is a state in which the second contact cannot be released due to the translation, and therefore, even when any of the operators 521 to 524 is supposedly operated, the translation is prohibited in step S25, and therefore the projection image Qu_a is in a stopped state.

However, even in a state where the translation prohibition condition is satisfied, the operation on the operator 526 that designates the reduction is accepted (since the determination result in step S26 is “No”), and therefore the projection image Qu_a is reduced. Therefore, after the reduction, the translation of the projection image Qu_a due to the operation on the operators 521 to 524, or the expansion of the projection image Qu_a due to the operation on the operator 525 becomes possible in some cases.

Note that in the embodiment, there is adopted the configuration in which when the projection image Qu_a is expanded due to the operation on the operator 525, the projection image Qu_a is expanded with reference to the center Cen at a constant magnification (initial magnification) in a similar shape. This configuration is not a limitation, and it is possible to adopt a configuration in which when the time T during which the operation of the operator 525 continues becomes equal to or longer than the threshold value Tth, the projection image Qu_a is expanded at a magnification larger than the initial magnification described above similarly to the translation. According to this configuration, when the time T in which the operation on the operator 525 continues is less than the threshold value Tth, the projection image Qu_a is expanded at the initial magnification every cycle time, and therefore, the projection image is expanded at the first speed, and when the time T becomes equal to or longer than the threshold value Tth, the projection image Qu_a is expanded at the magnification larger than the initial magnification every cycle time, and therefore the projection image Qu_a is expanded at the second speed higher than the first speed.

Further, it is possible to adopt a configuration in which when the projection image Qu_a is expanded due to the operation on the operator 525 and makes contact with the outer edge of the drawn image Qu at the second speed, the projection image Qu_a temporarily stops for the period St similarly to the translation.

According to this configuration, the operability of the user is improved similarly to the translation.

Note that in this configuration, the period St may be set or changed before the expansion.

A comparative example for explaining the superiority in the present embodiment will be described. In the comparative example, the projection image Qu_a is moved in the direction designated by the operators 521 to 524 until the projection image Qu_a comes into contact with the outer edge of the drawn image Qu in the liquid crystal panel 100.

In the comparative example, for example, when the projection image Qu_a comes into contact with the outer edge of the drawn image Qu by moving in the leftward direction due to the operation on the operator 523, the operation on the operator 521 different from the previous operation is required in order to move the projection image Qu_a in the upward direction. That is, in the comparative example, it is necessary to operate two different operators separately in two operations. In contrast, in the present embodiment, the translation is performed from the leftward direction to the upward direction by continuing the operation on the same operator 523, the operability of the user is improved.

Further, in the comparative example, for example, when the projection image Qu_a is located at the upper left end of the drawn image Qu as shown in FIG. 34 or FIG. 35, in order to restore the position shown in FIG. 32 or FIG. 33, the operation on the operator 522 is required after the operation on the operator 524. In contrast, in the present embodiment, since the operation on the operator 522 is sufficient, the operability of the user is improved.

According to the projection method related to the present embodiment, when the operators 521 to 524 that designate the translation of the projection image Qu_a are operated to thereby bring the projection image Qu_a into contact with the outer edge that is the maximum projection range of the drawn image Qu, and then that operator is operated, the projection image Qu_a moves along the outer edge that the projection image Qu_a has made contact with. Therefore, it becomes unnecessary for the user to take a trouble of changing the translation direction, and thus the operability is improved.

In addition, when the operator 525 that designates the expansion of the projection image Qu_a is operated to thereby bring the projection image Qu_a into contact with the outer edge and then that operator is operated, the projection image Qu_a similarly moves along the outer edge that the projection image Qu_a has made contact with, and therefore, it becomes unnecessary for the user to take the trouble of changing the translation direction, and thus, the operability is improved.

Further, in the embodiment, when the time in which the operation on any one of the operators 521 to 524 continues is less than the threshold value Tth, the projection image Qu_a moves at the first speed, and when that time becomes equal to or longer than the threshold value Tth, the projection image Qu_a moves at the second speed that is higher than the first speed, and therefore, operability reflecting the intention of the user is provided.

Note that even in a configuration in which the projection image Qu_a is expanded at the second speed higher than the first speed when the duration of the operation on the operator 525 is equal to or longer than the threshold value Tth, the operability reflecting the user's intention is similarly provided.

In the embodiment, when the projection image Qu_a comes into contact with the outer edge of the drawn image Qu at the second speed higher than the first speed, the translation of the projection image Qu_a temporarily stops during the period St before the translation along the outer edge, and therefore, a time margin of the operation for the user is provided. This further improves the operability for the user.

Note that also in the configuration in which when the duration of the operation on the operator 525 is less than the threshold value Tth, the projection image Qu_a is expanded at the first speed, and when the duration is equal to or longer than the threshold value Tth, the projection image Qu_a is expanded at the second speed higher than the first speed, the expansion temporarily stops when the projection image Qu_a comes into contact with the outer edge of the drawn image Qu, and therefore, the operability of the user is improved similarly to the translation.

Since the period St can be set or changed before the translation or the expansion, the period of the temporal stoppage can be adjusted to the user's preference.

Incidentally, in the embodiment, there is adopted the configuration in which when the projection image Qu_a makes contact with the outer edge of the drawn image Qu due to the operation of any of the operators 521 to 524, the projection image Qu_a is moved along a direction that can be represented by the composite vector of the vector in the translation direction designated by the operator and the vector in a direction orthogonal to the translation direction when viewed on the projection surface S, out of the two directions along the outer edge when the operation of that operator continues.

In this configuration, since the direction along the outer edge is different from the translation direction designated by the operator, the user may feel uncomfortable in some cases. For example, as shown in FIG. 30, when the projection image Qu_a has contact with the outer edge of the drawn image due to the operation on the operator 523, the projection image Qu_a moves in the direction from the vertex A toward the vertex D in the outer edge as shown in FIG. 32 when the operation on the operator 523 continues. Since the direction from the vertex A toward the vertex D is significantly different from the leftward direction designated by the operation on the operator 523, the user may feel uncomfortable in some cases.

Therefore, the embodiment may be modified as follows.

Particularly, first, a vector representing the translation direction along the outer edge is decomposed into a vector in the translation direction designated by the operator operated in a state where the projection image Qu_a is in contact with the outer edge of the drawn image Qu, and a vector in a direction orthogonal to the translation direction when viewed on the projection surface S.

Second, the magnitude of the vector in the translation direction designated by the operator and the magnitude of the vector in the direction orthogonal to the translation direction are compared with each other.

Third, when the magnitude of the vector in the translation direction designated by the operator is smaller than the magnitude of the vector in the direction orthogonal to the translation direction, the translation in the direction along the outer edge is prohibited after the contact, and when the magnitude of the vector in the translation direction is larger than the magnitude of the vector in the direction orthogonal to the translation direction, the translation in the direction along the outer edge is permitted after the contact.

For example, a state in which the projection image Qu_a is in contact with the outer edge of the drawn image Qu as illustrated in FIG. 39 is considered.

Considering when the operator 523 that designates the leftward direction is operated in this state, the vector AD representing the translation direction along the outer edge can be decomposed into a vector BaAa in the leftward direction designated by the operator 523 and a vector AaDa in the upward direction orthogonal to the vector BaAa.

In other words, the vector AD representing the translation direction along the outer edge can be represented by a composite vector of the vector BaAa in the leftward direction designated by the operator 523 and the vector AaDa in the upward direction orthogonal to the vector BaAa.

In this case, since the magnitude of the vector BaAa is smaller than the magnitude of the vector AaDa, the projection image Qu_a is prohibited from moving in the direction of the vector AD in the state where the projection image Qu_a is in contact with the outer edge of the drawn image Qu due to the operation of the operator 523, and therefore, the projection image Qu_a does not move along the outer edge of the drawn image Qu.

On the other hand, when the operator 522 that designates the downward direction is operated in the state shown in FIG. 40, that is, in the same state as FIG. 39, will be considered. When viewed on the projection surface S, the vector DA representing the translation direction along the outer edge can be decomposed into a vector DaAa in the downward direction designated by the operator 522 and a vector AaBa in the rightward direction orthogonal to that vector DaAa.

In other words, the vector DA representing the translation direction along the outer edge can be represented by a composite vector of the vector DaAa in the downward direction designated by the operator 522 and the vector AaBa in the rightward direction orthogonal to the vector DaAa.

In this case, since the magnitude of the vector DaAa is larger than the magnitude of the vector AaBa, the projection image Qu_a is permitted to move in the direction of the vector DA in the state where the projection image Qu_a is in contact with the outer edge of the drawn image Qu due to the operation of the operator 522.

According to such a method, when the operator that continues the contact is operated in a state where the projection image Qu_a is in contact with the outer edge of the drawn image, the translation of the projection image Qu_a that makes the user feel uncomfortable is prohibited, while the translation of the projection image Qu_a weak in uncomfortable feeling is permitted. Therefore, it is possible to reduce the degree of uncomfortable feeling provided to the user by the translation of the projection image Qu_a after the contact.

Note that the translation in a state where the projection image Qu_a is in contact with the outer edge of the drawn image has been described here, but substantially the same can be applied to the expansion of the projection image Qu_a by replacing the translation direction with the expansion direction.

Further, in the embodiment and the modified examples, the liquid crystal panel 100 (100 R, 100G, and 100B) is described as an example of the light modulation device, but other examples such as an organic electroluminescent device or a mirror device can be used. Note that the mirror device means a device that includes a mirror for each pixel and is configured to electrostatically switch the reflection direction of light to turn on or off.

The present disclosure will be summarized below as supplementary notes.

A projection method according to Supplementary Note 1 includes: by a main body including a light modulation device that is configured to draw a drawn image and a projection image obtained by reducing the drawn image, and that is configured to modulate light from a light source, projecting the drawn image or the projection image on a projection surface; receiving a first operation for moving the projection image relative to the projection surface or a second operation for expanding the projection image; and moving the projection image along an outer edge of the drawn image in accordance with the first operation or the second operation when the projection image makes contact with the outer edge by receiving the first operation or the second operation and when the first operation or the second operation continues. In other words, the projection method according to Supplementary Note 1 includes moving, in a case where the first operation or the second operation continues after the projection image makes contact with the outer edge by receiving the first operation or the second operation, the projection image along the outer edge of the drawn image in accordance with the first operation or the second operation.

For example, when the drawn image is projected on the projection surface in a state where the main body is inclined to the projection surface, an outer shape of a maximum projection range is not a rectangle but a distorted quadrangle. According to the projection method related to Supplementary Note 1, the projection image moves along the outer edge when the first operation or the second operation is received after the projection image makes contact with the outer edge that is the maximum projection range of the drawn image. Therefore, it becomes unnecessary for the user to take a trouble of changing the translation direction, and thus the operability is improved.

Note that the “drawn image” is an image obtained by the modulation by the light modulation device. The drawn image is rectangular when projected d from a direction orthogonal to the projection surface, but is distorted to a quadrangle when projected in a state of being inclined with respect to the projection surface. The “projection image” is an image adjusted into, for example, a rectangle in the drawn image. The “outer edge” is an edged portion of the drawn image. The “contact” is not a physical contact, but means that a vertex or a side of drawing pixels is in geometric contact with a vertex or a side of the drawn image. The first operation or the second operation may typically be designated by an operation on a physical key such as an arrow key or a cross key, or may be designated by an operation on a key displayed on the screen.

A projection method according to Supplementary Note 2 is the projection method according to Supplementary Note 1, wherein when the projection image comes into contact with the outer edge by receiving the first operation or the second operation, and when a direction of the translation designated by the first operation or a direction of the expansion designated by the second operation and a direction of the outer edge that the projection image makes contact with satisfy a predetermined condition, the projection image does not move along the outer edge regardless of the first operation or the second operation.

When the projection image comes into contact with the outer edge of the drawn image by receiving the first operation or the second operation, when the direction of the movement designated by the first operation or the direction of the expansion designated by the second operation is significantly different from the translation direction along the outer edge, the direction may be contrary to the direction intended by the user in some cases. According to the projection method related to Supplementary Note 2, it is possible to prevent the projection image from moving or expanding in a direction that is not intended by the user.

A projection method according to Supplementary Note 3 is the projection method according to Supplementary Note 2, wherein the predetermined condition is that when a translation vector of the projection image along the outer edge is represented by a composite vector of a first vector component in a direction of the translation designated by the first operation or in a direction of the expansion designated by the second operation, and a second vector component orthogonal to the direction of the translation designated by the first operation or the direction of the expansion designated by the second operation, the first vector component is smaller than the second vector component. According to the projection method related to Supplementary Note 3, when the projection image is likely to move or expand in a direction not intended by the user, the projection image stops in a state of being in contact with the outer edge of the drawn image, and therefore, it is possible to prevent the projection image from moving or expanding in the direction not intended by the user.

A projection method according to Supplementary Note 4 is the projection method according to any one of Supplementary Note 1 through Supplementary Note 3, wherein when a duration of the first operation or the second operation is a first time period, the projection image moves or expands at a first speed, and when the duration is a second time period longer than the first time period, the projection image moves or expands at a second speed higher than the first speed. When the first operation or the second operation is accepted for the second time period longer than the first time period, it is conceivable that the user intends to move or expand the drawn image quickly. According to the projection method related to Supplementary Note 4, when the first operation or the second operation is received for the second time period, the translation or the expansion of the projection image is performed at the second speed higher than the first speed. Therefore, operability reflecting the intention of the user is provided.

A projection method according to Supplementary Note 5 is the projection method according to Supplementary Note 4, wherein when the projection image makes contact with the outer edge at the second speed and when the first operation or the second operation continues, the translation or the expansion of the projection image is stopped for a first period before the projection image moves along the outer edge in accordance with the first operation or before the projection image expands along the outer edge in accordance with the second operation.

From the viewpoint of the user, when the projection image makes contact with the outer edge of the drawn image at the second speed higher than the first speed, the previous translation and so on of the projection image change to the translation and so on along the outer edge of the drawn image, and therefore the translation and so on of the projection image may be performed in a direction not intended by the user in some cases. According to the projection method related to Supplementary Note 5, the translation is temporarily stopped when the projection image comes into contact with the outer edge of the drawn image at the second speed, and therefore, a time margin of the operation for the user is provided. This further improves the operability for the user.

A projection method according to Supplementary Note 6 is the projection method according to Supplementary Note 5, wherein a third operation for setting or changing the first period is received before receiving the first operation or the second operation. According to the projection method related to Supplementary Note 6, it is possible to set an optimum period for the user.

A projector according to Supplementary Note 7 includes: a light modulation device configured to draw a drawn image and a projection image obtained by reducing the drawn image; a projection lens configured to project the drawn image or the projection image onto a projection surface; an operator configured to designate a first operation for moving the projection image relative to the projection surface or a second operation for expanding the projection image; and a control device configured to move the projection image along an outer edge of the drawn image in accordance with the first operation or the second operation when the projection image makes contact with the outer edge by receiving the first operation or the second operation designated by the operator and when the first operation or the second operation continues.

According to the projector related to Supplementary Note 7, similarly to Supplementary Note 1, it becomes unnecessary for the user to take a trouble of changing the translation direction, and thus the operability is improved.

A non-transitory computer-readable storage medium storing a program according to Supplementary Note 8 is configured to cause a computer that is configured to control a light modulation device, the light modulation device being configured to draw a drawn image and a projection image obtained by reducing the drawn image and being configured to modulate light from a light source, to execute processing including: receiving a first operation for moving the projection image relative to a projection surface or a second operation for expanding the projection image; and moving the projection image along an outer edge of the drawn image in accordance with the first operation or the second operation when the projection image makes contact with the outer edge by receiving the first operation or the second operation and when the first operation or the second operation continues.

According to the non-transitory computer-readable storage medium storing the program related to Supplementary Note 8, similarly to Supplementary Note 1, it becomes unnecessary for the user to take a trouble of changing the translation direction, and thus the operability is improved.

What is claimed is:

1. A projection method comprising:
projecting, by a main body including a light modulation device that is configured to draw a drawn image and a projection image obtained by reducing the drawn image and that is configured to modulate light from a light source, the drawn image or the projection image on a projection surface;
receiving a first operation for moving the projection image relative to the projection surface or a second operation for expanding the projection image; and
moving the projection image along an outer edge of the drawn image in accordance with the first operation or the second operation when the projection image makes contact with the outer edge by receiving the first operation or the second operation and when the first operation or the second operation continues.

2. The projection method according to claim 1, wherein
when the projection image comes into contact with the outer edge by receiving the first operation or the second operation, and when a direction of the movement designated by the first operation or a direction of the expansion designated by the second operation and a direction of the outer edge that the projection image makes contact with satisfy a predetermined condition,
the projection image does not move along the outer edge regardless of the first operation or the second operation.

3. The projection method according to claim 2, wherein
the predetermined condition is that when a translation vector of the projection image along the outer edge is represented by a composite vector of a first vector component in a direction of the movement designated by the first operation or in a direction of the expansion designated by the second operation, and a second vector component orthogonal to the direction of the movement designated by the first operation or the direction of the expansion designated by the second operation, the first vector component is smaller than the second vector component.

4. The projection method according to claim 1, wherein
when a duration of the first operation or the second operation is a first time period, the projection image moves or expands at a first speed, and
when the duration is a second time period longer than the first time period, the projection image moves or expands at a second speed higher than the first speed.

5. The projection method according to claim 4, wherein
when the projection image makes contact with the outer edge at the second speed and when the first operation or the second operation continues,
the movement or the expansion of the projection image is stopped for a first period before the projection image moves along the outer edge in accordance with the first operation or before the projection image expands along the outer edge in accordance with the second operation.

6. The projection method according to claim 5, wherein
a third operation for setting or changing the first period is received before receiving the first operation or the second operation.

7. A projector comprising:
a light modulation device configured to draw a drawn image and a projection image obtained by reducing the drawn image;
a projection lens configured to project the drawn image or the projection image onto a projection surface;
an operator configured to designate a first operation for moving the projection image relative to the projection surface or a second operation for expanding the projection image; and
a control device configured to move the projection image along an outer edge of the drawn image in accordance with the first operation or the second operation when the projection image makes contact with the outer edge by receiving the first operation or the second operation designated by the operator and when the first operation or the second operation continues.

8. A non-transitory computer-readable storage medium storing a program configured to cause a computer that is configured to control a light modulation device, the light modulation device being configured to draw a drawn image and a projection image obtained by reducing the drawn image and being configured to modulate light from a light source, to execute processing comprising:
receiving a first operation for moving the projection image relative to a projection surface or a second operation for expanding the projection image; and
moving the projection image along an outer edge of the drawn image in accordance with the first operation or the second operation when the projection image makes contact with the outer edge by receiving the first operation or the second operation and when the first operation or the second operation continues.
